(19) United States
(12) Patent Application Publication
(10) Pub. No.: US 2024/0400910 A1
(43) Pub. Date: Dec. 5, 2024

(54) A process for production of fossil free hydrocarbons from lignocellulosic material

(71) Applicant: SUND Group s.r.o., Prag (CZ)

(72) Inventor: Leif Engelthon, Sundsvall (SE)

(73) Assignee: SUND Group s.r.o., Prag (CZ)

(21) Appl. No.: 18/699,170

(22) PCT Filed: Oct. 7, 2022
(86) PCT No.: PCT/EP2022/077894

§ 371 Date: Apr. 5, 2024

(30) Foreign Application Priority Data
Oct. 7, 2021 (SE) 2151227-2

(51) Int. Cl. C10G 1/00; C10G 53/04

(52) U.S. Cl. CPC C10G 1/006; C10G 53/04; C10G 2300/1014

(57) ABSTRACT

The present invention relates to a process for production of fossil free hydrocarbons from lignocellulosic material comprising the steps of: A-hydrolyzing the lignocellulosic material using ammonium bisulfite, whereby the conditions of the hydrolysis are being controlled by regulating pH, temperature, color, pressure, sulfite content, kappa number and/or R18, such that a desired product can be obtained for further processing of the hydrolyzed material. B-hydrothermal carbonizing the hydrolyzed material that is not further processed using hydrothermal liquefaction (HTL) or hydrothermal carbonization (HTC) to produce at least biooil. C-separating liquids and gases from prior process steps for cleaning and reuse of liquid, gases and chemicals contained therein. D-generating electricity and/or steam to perform the steps of the process by using liquid, gas, biooil or bio-coal produced in the prior process steps, to operate at least a part of the steps of the process.

### FIELD OF THE INVENTION

The present invention relates to a process for production of fossil free or bio-hydrocarbons from lignocellulosic material comprising the steps of hydrolysis, hydrothermal carbonization at least a part of the hydrolyzed material, separating liquids, including oil, and gases from prior process steps and, generating electricity and/or steam to operate at least a part of the steps of the process.

### Background of the Invention and Prior Art

The production of recycled organic material at an economically suitable manner is challenging. The production of cellulose products, such as paper from wood is in general an energy consuming process using chemicals that may have a negative impact on the environment. Also, the production of biooils from fiber rich organic materials often has a negative impact on the environment in the sense that chemicals, such as sulfur and carbon dioxide are being released into the atmosphere.

The choice of feedstock in the production of biogas and bio-oils is dependent on the availability and costs. The composition of the feed stock is important for processing the material. Lignocellulose materials, such as wood and herbaceous energy crops, contain varying amounts of lignin, hemicellulose, and cellulose. Upon hydrolysis and hydrothermal carbonization or liquefaction, these large polymolecules breakdown into a range of smaller compounds. Municipal waste and sewage sludge contain significant amounts of nitrogen from the proteins present in the waste. Algae contain proteins, carbohydrates and lipids break down in various organic compounds.

In total, a tree consists of 10-15% bark. The forest industry therefore produces large amounts of bark when processing trees. As of today, it is mostly incinerated and used as fuel by pulp mills. However, bark also contains several chemicals that could be used in production of pharmaceuticals, cosmetics or foodstuffs. Suberin Bark from birch trees can be raw material for production of special polymers with designed properties. Betulin from betulin bark has a function to protect trees from microorganisms and could therefore be of interest in the medical field. Additionally, betulin can be used for pigmentation in the cosmetics industry or as an antioxidant in health products. Furthermore, bark from pine and spruce trees contains up to 6% condensed tannins, with has a wide number of applications, e.g. as an additive in food due to its antioxidant properties or for tanning leather. Tannins can also be combined with furfuryl alcohol to produce insulating material.

Pulp and paper industry produce large amounts of sewage that must be cleaned before water can return to nature. Sedimentation combined with biological and/or chemical cleaning is used to clean the water. The remaining sludge is usually dewatered using presses or centrifuges. Porteous is a process developed to reduce a water content in organic material before incineration. It comprised heating the organic material to temperatures of 185-200° C. for 30 min. However, this process required a lot of energy. The remaining sludge is than discarded or burned. Both processes are environmentally unfriendly. Cambi/Krepo and BioCon-processes have been developed to recycle at least phosphate and metals from the sludge. In Cambi/Krepo, thermic hydrolysis and burning of sludge combined with oxidation of hydrolyzed material is used. Phosphate and metals are recycled using phosphate acid. In BioCon ashes of burned sludge is treated to recycle phosphates and metals. Both processes are expensive and complex and suitable for large scale operations.

Several processes have been developed to improve processes for biooil and paper production. In some of these processes, the organic material from wood- or water waste, or agricultural waste is being hydrolyzed prior to using the material in a decomposing process for production of biogases. Hydrolysis has also been used in combination with Sabatier and Fischer-Tropisch processes to produce biogases and biooils.

U.S. Pat. No. 8,278,362 discloses a process for production of biooil using a combination of Fischer-Tropsch and Sabatier processes starting from carbon dioxide from air. Heat from the exothermically process is being used in the system

U.S. Pat. No. 9,816,035 discloses a process to produce synthetic hydrocarbons from biomass using a Fischer-Tropsch process. The biomass may be pre-treated using hydrothermal hydrolysis.

U.S. Pat. Nos. 9,557,057, 8,603,430 and 20,142,73141 disclose processes to produce synthetic hydrocarbons from biomass using a Fischer-Tropsch process.

The Sabatier and Fischer-Tropsch processes may also be combined with electrolysis to produce the gases needed in these processes.

The sulfite processes that exist today are very similar to a sulphate process, and these processes cannot assimilate all wood substances other than for combustion. With today's sulfite and sulphate processes, it is not possible to handle a higher wood yield than 60-70% in a biorefinery, as 30-40% of the wood's substances must be used for chemical recycling. A yield of a maximum of 40% is achieved when bark is included.

Sulfite and sulfate processes create emissions because chemical recycling through incineration is needed. Even though the technologies have come a long way when it comes to emissions of organic and inorganic substances, and the use of fossil fuels has been reduced, climate emissions still exist in the form of carbon dioxide emission, even if these come from biomasses.

Authorities and society are increasingly making demands on the industry to reduce emissions, which is remedied by more expensive and more advanced technology, which does not create new revenues but rather creates expenses in the form of additional operating costs. At the same time, it is a matter of time before authorities will demand emission reductions of greenhouse gases also from biogenic emissions in order to slow down the climate changes that are created through emissions.

It is also an unsustainable strategy that when society strives to replace fossil products with forest-based products, they must then burn them to a greater extent in order to create energy for the processes and recycle the chemicals.

In order to increase the use of forest raw materials and at the same time maintain biological diversity, the yield of processing lignocellulosic material must increase.

Lignin is a polymer of propyl phenol units, namely, coniferyl alcohol and sinapyl alcohol, with a minor quantity of p-coumaryl alcohol. The complex of these components is cross-linked together through carbon-carbon, ester, and ether linkages. The heterogeneity of lignin depends on the origin of the material. Most lignin produced as a byproduct in paper industry is burned to produce energy. Some lignin is used for production of sulfide containing lignin such as lignosulfonate or Kraft-lignin. Some lignin is used in epoxy-resins, dispersion agents, etc. Attempts have been made to use lignin as a dust-binder in asphalt, but this was commercially not feasible, which is why salts, minerals are still used. There is a need for asphalt, which is environmentally more friendly and comprising less fossil-originating coal.

So called sulfite hydrolysis has been done to produce cellulose from wood products. However, the yield of these processes is low and therefore expensive to use to produce cellulose rich products, such as viscose material.

Sulfite cooking/hydrolysis is performed in for example the paper industry, whereby sulfite is used in a hydrolysis step in the process. The active components in a sulfite hydrolysis process are H⁺, SO₂ and HSO³⁻. In a bisulfite hydrolysis process, the active components are the same but the concentration of HSO³⁻ is larger compared to a sulfide hydrolysis.

Sulfite hydrolysis is normally done in batches because this facilitates control of the hydrolysis reactions in relation to hydrolysis liquid-degrading side reactions. However, it is also possible to perform the hydrolysis in a continuous boiler/reactor/tank, but the risk for adverse reactions, such as liquid decay and the occurrence of black cook (black residues) is high. The reason for this is that during such hydrolysis, all the different stages of the hydrolysis occur simultaneously in the reactor, which easily leads to strong adverse reactions.

Batch sulfite hydrolysis is usually done over a long residence time at a relatively low temperature, which is to a large extent linked to the effort to achieve an even hydrolysis. For a continuous reactor, however, such a schedule would involve extremely large reactors. Therefore, during continuous hydrolysis, too low a hydrolysis temperature is avoided for the hydrolysis time and thus the hydrolysis size to be reasonable. Preferably, full or almost full hydrolysis temperature are used from the very beginning of the hydrolysis. However, the risk for disturbing mixing of hydrolysis liquid in different stages of the hydrolysis with decomposition of liquid and black cooking as a result, increases at the same time. Such a mixture can to some extent be accepted for acid sulfite hydrolysis but not for the more sensitive bisulfite hydrolysis.

The buffer capacity of the hydrolysis liquid in a bisulfite hydrolysis is less compared to a sulfite hydrolysis. The active components are responsible for the breakdown of lignin and hemicellulose as well as sulphonation of lignin. The hydrolysis process can be controlled and steered towards a desired end-product by among others controlling the equilibrium between the active components H⁺, SO₂ and HSO³⁻ in the hydrolysis liquid. By measuring the partial SO₂ pressure and measuring the amount of bonded SO₂ in the liquid, the amount of H⁺ and HSO³⁻ can be controlled at any temperature and pressure. For example, if the temperature increases, the partial SO₂ pressure increases, whereby the concentration of H⁺ decreases and hence the pH increases. By de-gassing the hydrolysis liquid during hydrolysis, the partial SO₂ pressure can be controlled.

(Bi) sulfite hydrolysis liquid can be analyzed by measuring total SO₂, free SO₂ and bound SO₂ by using an iodine- and sodium hydroxy-titration process (PAUL F., Mitt. Klosterneuburg, Rebeu. Wein, 1958, ser. A, 821., OIV-MA-AS323-04A: R2012) The amount of total SO₂ is a sum of all sulfide compounds in the liquid, i.e. SO₂, HSO³⁻ and SO₃²⁻. Bound SO₂ is defined as the amount of SO₃²⁻ in the liquid. The total free amount of SO₂ is determined by total SO₂ minus (2× bound SO₂).

The hydrolysis normally takes place outside the buffer areas of the sulfite ions, which means that the pH tends to drop significantly during the hydrolysis, especially during long-term hydrolysis. Low kappa numbers are therefore difficult to achieve without the mass strength is deteriorating. Some pH adjustment to the desired higher pH can be done by degassing of free SO₂ when the pH begins to drop in the hydrolysis. Starting pH may be about 4-5. The main reaction with sulfonation of the lignin does not in itself affect the pH, but side reactions which consume HSO³⁻ ions gradually lower the pH, at the same time as thiosulphate (S₂O₃²⁻) ions are formed, which in turn catalyze the decomposition of the hydrolysis liquid. The practice is therefore that in a bisulfite reactor, significantly more bisulfite (HSO³⁻ ions) is invested to provide sufficient space also for side reactions, i.e. net approx. 80 kg/h bound SO₂ compared with 40-50 kg/h for acid sulfite hydrolysis of pulp. During normal bisulfite hydrolysis to kappa numbers around 50 or higher, these side reactions affect the hydrolysis to a relatively moderate degree. When hydrolyzed to kappa numbers 20-25, on the other hand, the stability of the reactor gradually deteriorates, which manifests itself in lowered pH and increased amount of thiosulfate ions, in contrast to the acid sulfite reactor where the thiosulfate ions are fixed by the lignin and “neutralized”. The thiosulphate ions catalyze the decomposition of the coke acid (R1-R3), which can lead to strong lignin condensation and finally to the so-called “Black cook”.

It has proved difficult to achieve lower kappa numbers than 32 in a continuous sulfite hydrolysis using bisulfite. It has been found that from kappa number 32 there is a faster decomposition of acid material in a continuous reactor compared to a batch reactor. This is due to several related factors, but above all to an excessive mixture of the liquid when the kappa number is less than 32.

U.S. Pat. No. 4,634,499 discloses a hydrolysis process for hard wood using ammonia (NH3) and sulfur dioxide (SO2) to produce lignosulphonate. Use of SO2 is difficult in a continuous process, because of degradation of polysaccharides, glucose and the like. A black cook develops during hydrolysis. Further processing the material after a SO2 cook is harder because of increasing amounts of impurities, toxins, and the like. Use of NH3 and SO2 in hydrolysis reduces the yield compared to use of NH4HSO3 with regard to ethanol, viscose and ethanol production.

The hydrolysis process is also controlled by pulp viscosity (which dependents on both cellulose degree of polymerization (DP) and cellulose content) which is very important in a dissolving product and for the R18, which is related to the cellulose content.

In case of sulfite viscose pulp hydrolysis, it is assumed that the lignin release is reduced to a low content of residual lignin, and then small variations in the lignin content are of secondary importance. It is desirable that the hemicellulose release in the liquid be as complete as possible, but the final adjustment of the hemicellulose content can be made in an alkali processing step.

An important reason for this difference compared to sulphate pulp is that the lignin in the sulfite pulps has been hydrophilized by the introduction of sulfonate groups in the lignin, while the sulphate pulp is limited hydrophilic. The sulfite lignin thereby basically requires only a release of reasonably large lignin fragments for lignin dissolution in the initial bleaching. The lignin release in e.g. a chlorine dioxide step is extensive, while a subsequent alkali step mainly complements, but not dominates the release of lignin. For sulphate pulp, it is the opposite.

Another important difference, which affects the bleaching, is that wood lignin is discolored to a lesser extent in the sulfite processes, while in the sulphate process it is strongly discolored. Since sulfite pulps are relatively easily bleached, bleaching can be made easier than for a sulphate pulp. Modern bleaching sequences for sulfite pulps are largely based on so-called TCF bleaching, mainly with hydrogen peroxide without chlorine dioxide. This improves the environmental print of the process of the invention.

Bleaching of sulfite pulp has traditionally given a slightly higher total yield than sulphate pulp before bleaching. However, when bleaching the sulfite pulp, there has been a stronger reduction in yield rate compared to when bleaching sulphate pulp. The primary reason is that the carbohydrates of the sulfite material are not alkali-stabilized, in contrast to the sulphate material. This difference in alkali stabilization is especially significant in the manufacture of dissolving pulp. Sulphate-coated pulp to dissolving quality has the difficulty that the remaining hemicellulose is alkali-stabilized and thus difficult to release in a post-treatment, at the same time as this remaining hemicellulose is difficult to accept in a normal viscose process. This means that a post-treatment of the sulphate pulp significantly affects the cellulose yield negatively.

Cellulose yield in the sulfite hydrolysis of dissolving pulp, is close to 100% or just below after hydrolysis because the cellulose is the main component in a dissolving pulp. While in a sulfate dissolving pulp, the cellulose yield is below 90%.

This is usually solved by adjusting the alkalinity after sulfite hydrolysis, but with negative consequences, which, among other things decreases the cellulose yield and strength but instead increases the degree of refinement, i.e. increases the R18 value. The cellulose yield decreases with the alkali refining as the concentration of hydroxide ions (OH) increases. Usually, NaOH is used in the alkali refining/adjustment of the sulfite material.

Other negative aspects are the costs because the alkali chemicals cannot be recycled and an increase on the load for water purification and the accompanying environmental aspects.

Furthermore, in a continuous hydrolysis it may be advantageous to pre-treat or impregnate of lignocellulosic material prior to hydrolysis. The relationship between the SO₂ pressure in the gas phase and the SO₂ content in the liquid phase applies to the relationship outside the wood chips pieces. Inside the wood chips, the introduction of sulfonate groups into the lignin will affect the pH, which will then be lower than in the free solution. This phenomenon is explained by the so-called Donnan theory. The sulfonate groups on undissolved lignin and on more or less dissolved lignin molecules, which have not yet been able to diffuse out of the wood structure, give a larger proportion of negative groups inside the wood structure compared to that in the free liquid. This must be balanced with an increase in the number of positive cations, which in turn requires an increased content of H⁺ ions inside the wood chips to prevent a difference between the interior of the wood chips and the outer liquid with regard to the concentration of base ions (NH₃). It thus becomes more acidic inside the chips when the sulfonation has gained momentum and this pH difference is greatest at the beginning of the hydrolysis. This also means that a higher hydrolysis speed can be used for monovalent bases due to the higher hydrogen ion content.

Therefore, it may be extra important to impregnate the wood chips before hydrolysis.

One of the major disadvantages of the sulfite process is the presence of resin. Wood resin is a complex mixture. Spruce resin has a higher content of free fatty acids and as esters than resin acids, while birch resin consists almost exclusively of fatty acids in free and bound form and contains almost no resin acids. In addition, there is an annual variation of the wood resin. The wood resin is also dependent on the location of where the lignocellulosic material or tree is growing. Resin content in a dissolving pulp is important for further processing into different products, but the presence of the resin is within very narrow limits and is preferably from about 0.10 to 0.30% for a dissolving pulp.

Channel resin is released and can be washed out relatively easily, while the parenchymal resin is enclosed in the moderately delignified cells. Previously, the problem with the parenchymal resin was solved via fiber fractionation. Wood resin has also been dissolved in an alkaline bleaching step and then the resin is kneaded out mechanically, which costs chemicals and energy. The resin removal usually results in increased emission problems.

During the 1960s, a bisulfite process for production of a liner was developed that had better properties than kraft paper liner with a yield of 75% compared to 55-60% in sulphate-produced kraft process. However, it turned out that the bisulfite liner was brittle in a dry environment.

In other semi-chemical processes, more neutral sulfite is now used to produce fluting, which is the wavy intermediate layer on a corrugated board. In thermochemical processes used for production of tissue, cardboard, etc. neutral sulfite is also used there. In these processes, sodium sulfite is used exclusively as a base.

Carbonization (including liquefication) is a process whereby polymeric biomass is depolymerized into monomers. Biomaterial is present in a solvent, such as a lower alcohols methanol to butanol together with a catalyst such as KOH, NaOH, KCO3 or Na2CO3. The solvents used are expensive and not recyclable. The catalysts, such as NaOH is neither re-used. Often a hydrogen donor must be added to the liquid to prevent radical formation during carbonization/liquidification. Hydrogen gas is often used under pressure, which complicates the process for safety and thus cost reasons. Hydrothermal liquefaction (HTL) has been used for processing biomass. For example, Jensen, C. U. et al., Biomass Conv. Bioref. (2017) 7, p 495-509 shows how HTL can be used to process biomass in two subsequent HTL reactors. The biomass is transported through the reactors with help of a metal spring that pushes and draws the slurry through the reactor. The metal spring is needed to prevent sticking of black cooking residues on the wall of the reactors.

Hydrothermal carbonization (HTC) has been used to convert organic material into gases, liquids and coal.

Many chemical substances in form of gas, liquid or solids would have a negative impact on the environment if these substances were released from the system that performs the process. It is advantageous to prevent release and preferably recycle such substances.

### SUMMARY OF THE INVENTION

It is an object of the present invention to at least partly overcome the above-mentioned problems, and to provide an improved process for production of fossil free hydrocarbon products from lignocellulosic material.

This object is achieved by a process as defined in claim 1.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A1), A2), A3) and/or A4),
   A1) hydrolyzing the lignocellulosic material using ammonium bisulfite at a temperature between 80 and 200° C. for a period of 0.5 to 36 hours and at a pressure between 0.1 and 1.5 MPa, and/or
   A2) hydrolyzing the lignocellulosic material using ammonium bisulfite at a temperature of 125 to 170° C., a pH of 4 to 7 for 2 to 6 hours and a liquid/material ratio of 2.5 to 4.5, and/or
   A3) hydrolyzing the lignocellulosic material using ammonium bisulfite at a temperature of 125 to 170° C., a pH of 4 to 7 for 2 to 6 hours and a liquid/material ratio of 2.5 to 4.5, and
      A3-S) hydrolyzing the obtained material in step A3) using sodium carbonate (20 to 35 wt %) at a temperature of 100 to 200° C., a pressure of 0.1 to 1 MPa for 0.5 to 4 hours, and/or
   A4) hydrolyzing the lignocellulosic material using ammonium bisulfite at a temperature of 70 to 170° C., a pH of 3 to 7 a pressure of 0.1 to 1.2 MPa, for 0.5 to 6 hours and a liquid/material ratio of 2.5 to 5, and
      A4-D) defibrating and/or beating the obtained material in step A4), and optionally A4-Df) removing fine material, and optionally, A4-R) adding recycled paper material to the defibrated material in step A4-D),
B) hydrothermal carbonizing/liquefaction a portion of the hydrolyzed material that is not further processed using hydrothermal liquefaction (HTL) or hydrothermal carbonization (HTC) to produce at least biooil,
C) separating liquids, including oil, and gases from prior process steps for cleaning and reuse of liquid, gases and chemicals contained therein, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A1), A2), A3) and/or A4) as outlined above,
B) hydrothermal carbonizing/liquefaction a portion of the hydrolyzed material that is not further processed using hydrothermal liquefaction (HTL) or hydrothermal carbonization (HTC) to produce at least biooil,
wherein step B) comprises or consists of the steps
   B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
   B-2) temporizing the heated material obtained in step B-1) further to at least 300° C., or to 300 to 400° C., optionally using induction heating,
   B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A1), A2), A3) and/or A4) as outlined above,
B) hydrothermal carbonizing/liquefaction a portion of the hydrolyzed material that is not further processed using hydrothermal liquefaction (HTL) or hydrothermal carbonization (HTC) to produce at least biooil,
C) separating liquids, including oil, and gases from prior process steps for cleaning and reuse of liquid, gases and chemicals contained therein,
wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A1), A2), A3) and/or A4) as outlined above,
B) hydrothermal carbonizing/liquefaction a portion of the hydrolyzed material that is not further processed using hydrothermal liquefaction (HTL) or hydrothermal carbonization (HTC) to produce at least biooil, wherein step B) comprises or consists of the steps
   B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
   B-2) temporizing the heated material obtained in step B-1) further to at least 300° C., or to 300 to 400° C., optionally using induction heating,
   B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein, wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

In some aspects, in the process as defined anywhere above, a cleaning step E) is performed to remove resin present in the lignocellulosic material comprising the steps of:
E1) treating wood chips with hot air at a temperature from 40 to 80° C. to accelerate resin maturation,
E2) filtering and fractioning the hydrolyzed material to remove a remaining resin.

In some aspects, in the process as defined anywhere above, an impregnation step F) is performed prior to hydrolysis comprising the steps of:
F-1) steaming the wood chips at a temperature of 80 to 150° C. at a pressure of 0.1 to 0.5 MPa during 1 to 30 minutes, or 1 to 15 minutes,
F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using the step A1) hydrolyzing the lignocellulosic material using ammonium bisulfite at a temperature between 80 and 200° C. for a period of 0.5 to 36 hours and at a pressure between 0.1 and 1.5 MPa,
B) hydrothermal carbonizing/liquefaction a portion of the hydrolyzed material that is not further processed using hydrothermal liquefaction (HTL) or hydrothermal carbonization (HTC) to produce at least biooil,
wherein step B) comprises or consists of the steps
   B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
   B-2) temporizing the heated material obtained in step B-1) further to at least 300° C., or to 300 to 400° C., optionally using induction heating,
   B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein,
   wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolyzing step A2) comprising or consisting of:
   optionally, E1) treating wood chips with hot air at a temperature between 4° and 80° C. to accelerate resin maturation,
   optionally, F-1) steaming the wood chips at a temperature of 80 to 150° C. at a pressure of 0.1 to 0.5 MPa during 1 to 30 minutes, or 1 to 15 minutes,
   optionally, F-2) pre-hydrolyzing the material obtained in step F1) using ammonium sulfite at a pH of 7 to 9, a temperature of 130 to 190° C., a pressure of 0.1 to 1.5 MPa for 0.5 to 2 hours,
   then hydrolyzing the obtained material in step A2) using ammonium bisulfite at a temperature of 130 to 170° C., a pH of 4 to 6 for 0.5 to 4 hours, at a pressure from 0.1 to 3, or 0.1 to 1 MPa followed by
   optionally, E2) filtering and fractioning the hydrolyzed material to remove a remaining resin,
B) hydrothermal carbonizing/liquefaction a portion of the hydrolyzed material that is not further processed using hydrothermal liquefaction (HTL) or hydrothermal carbonization (HTC) to produce at least biooil,
wherein step B) comprises or consists of the steps
   B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
   B-2) temporizing the heated material obtained in step B-1) further to at least 300° C., or to 300 to 400° C., optionally using induction heating,
   B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein,
   wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A3) comprising or consisting of:
   optionally, E1) treating wood chips with hot air at a temperature between 4° and 80° C. to accelerate resin maturation,
   optionally, F-1) steaming the wood chips at a temperature of 80 to 150° C. at a pressure of 0.1 to 0.5 MPa during 1 to 30 minutes, or 1 to 15 minutes,
   optionally, F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min,
   then hydrolyzing the obtained material in step A3) using ammonium bisulfite at a temperature of 125 to 170° C., a pH of 4 to 7 for 2 to 6 hours and a liquid/material ratio of 2.5 to 4.5, at a pressure from 0.1 to 3, or 0.1 to 1 MPa and
      A3-S) hydrolyzing the obtained material in step A3) using sodium carbonate (20 to 35 wt %) at a temperature of 100 to 200° C., a pressure of 0.1 to 1 MPa for 0.5 to 4 hours, followed by
   optionally, E2) filtering and fractioning the hydrolyzed material to remove a remaining resin,
B) hydrothermal carbonizing/liquefaction a portion of the hydrolyzed material that is not further processed using hydrothermal liquefaction (HTL) or hydrothermal carbonization (HTC) to produce at least biooil,
wherein step B) comprises or consists of the steps
   B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
   B-2) temporizing the heated material obtained in step B-1) further to at least 300° C., or to 300 to 400° C., optionally using induction heating,
   B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein,
   wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A3) comprising or consisting of:
   optionally, E1) treating wood chips with hot air at a temperature between 4° and 80° C. to accelerate resin maturation,
   optionally, F-1) steaming the wood chips at a temperature of 80 to 150° C. at a pressure of 0.1 to 0.5 MPa during 1 to 30 minutes, or 1 to 15 minutes,
   optionally, F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min,
   then hydrolyzing the obtained material in step A3) using ammonium bisulfite at a temperature of 125 to 170° C., a pH of 4 to 7 for 2 to 6 hours and a liquid/material ratio of 2.5 to 4.5, at a pressure from 0.1 to 3, or 0.1 to 1 MPa and
      A3-S) hydrolyzing the obtained material in step A3) using sodium carbonate (20 to 35 wt %) at a temperature of 100 to 200° C., a pressure of 0.1 to 1 MPa for 0.5 to 4 hours, followed by
   optionally, E2) filtering and fractioning the hydrolyzed material to remove a remaining resin,
      M-1) measuring a content of hydrolysed material from step A3-S) and mixing liquid and solid material to obtain material having a 5 to 45 wt %,
      M-2) drying a first portion of the starting material until a dry mass of 45 to 65 wt %, or 50 to 60 wt %, or 55 to 58 wt % is obtained,
      M-3) drying a second portion of the starting material in a heat exchanger prior to carbonization in step B),
      whereby the condensates from steps M-2) and M-3) are removed to recycle chemicals contained therein or are added to step M-1),
      M-4) steam heating the dried mass from step M-2) at 350 to 500° C., or 400 to 450° C., whereby the condensate is removed to recycle chemicals contained therein or is added to step M-1), and whereby the heat is re-used in the processes, such as in the heat exchanger,
      M-5) producing vanillin and lignosulfonate from the dried material obtained in step M-4), whereby any residues from step M-5) are reused in steps M-1), M-2) or M-3), and whereby the condensates are removed to recycle chemicals contained therein,
B) hydrothermal carbonizing/liquefaction a portion of the hydrolyzed material that is not further processed using hydrothermal liquefaction (HTL) or hydrothermal carbonization (HTC) to produce at least biooil,
   wherein step B) comprises or consists of the steps
      B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
      B-2) temporizing the heated material obtained in step B-1) further to at least 300° C., or to 300 to 400° C., optionally using induction heating,
      B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein,
   wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A3) comprising or consisting of:
   optionally, E1) treating wood chips with hot air at a temperature between 4° and 80° C. to accelerate resin maturation,
   optionally, F-1) steaming the wood chips at a temperature of 80 to 150° C. at a pressure of 0.1 to 0.5 MPa during 1 to 30 minutes, or 1 to 15 minutes,
   optionally, F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min,
   then hydrolyzing the obtained material in step A3) using ammonium bisulfite at a temperature of 125 to 170° C., a pH of 4 to 7 for 2 to 6 hours and a liquid/material ratio of 2.5 to 4.5, at a pressure from 0.1 to 3, or 0.1 to 1 MPa and
      A3-S) hydrolyzing the obtained material in step A3) using sodium carbonate (20 to 35 wt %) at a temperature of 100 to 200° C., a pressure of 0.1 to 1 MPa for 0.5 to 4 hours, followed by
   optionally, E2) filtering and fractioning the hydrolyzed material to remove a remaining resin,
      N1) filtering the hydrolyzed material
      N2) washing the filtered material
      N3) cleaning the washed material by
         N3-a) bleaching the washed material, and/or
         N3-b) dewatering the washed material, and
      N4) processing the material for use in cellulose products, such as paper, tissues or viscose material,
B) hydrothermal carbonizing/liquefaction a portion of the hydrolyzed material that is not further processed using hydrothermal liquefaction (HTL) or hydrothermal carbonization (HTC) to produce at least biooil,
wherein step B) comprises or consists of the steps
   B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
   B-2) temporizing the heated material obtained in step B-1) further to at least 300° C., or to 300 to 400° C., optionally using induction heating,
   B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein,
   wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A4) comprising or consisting of:
   optionally, E1) treating wood chips with hot air at a temperature between 40 and 80° C. to accelerate resin maturation,
   optionally, F-1) steaming the wood chips at a temperature of 80 to 150° C. at a pressure of 0.1 to 0.5 MPa during 1 to 30 minutes, or 1 to 15 minutes,
   optionally, F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min,
   then hydrolyzing the obtained material in step A4) using ammonium bisulfite at a temperature of 70 to 170° C., a pH of 3 to 7 a pressure of 0.1 to 1.2 MPa, for 0.5 to 6 hours and a liquid/material ratio of 2.5 to 5, and
   optionally, E2) filtering and fractioning the hydrolyzed material to remove a remaining resin,
   A4-D) defibrating and/or beating the obtained material in step A4), and optionally A4-Df) removing fine material, and
   optionally, A4-R) adding recycled paper material to the defibrated material in step A4-D),
B) hydrothermal carbonizing/liquefaction a portion of the hydrolyzed material that is not further processed using hydrothermal liquefaction (HTL) or hydrothermal carbonization (HTC) to produce at least biooil,
wherein step B) comprises or consists of the steps
   B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
   B-2) temporizing the heated material obtained in step B-1) further to at least 300° C., or to 300 to 400° C., optionally using induction heating,
   B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein,
wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

The invention relates to a process for production of fossil free or bio-hydrocarbons from lignocellulosic material comprising the steps of:
optionally precleaning lignocellulosic material,
   optionally, E1) treating wood chips with hot air at a temperature between 4° and 80° C. to accelerate resin maturation,
   optionally, F-1) steaming the wood chips at a temperature of 80 to 150° C. at a pressure of 0.1 to 0.5 MPa during 1 to 30 minutes, or 1 to 15 minutes,
   optionally, F-2) prehydrolysing the steamed biomass using NH4HSO3, a pH 3 to 7, a temperature 80 to 250° C., and an atmospheric pressure for 5 to 360 minutes,
   cleaning the prehydrolysed product,
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed, whereby hydrolysis is performed using hydrolysis steps A5),
   A5) hydrolysing the prehydrolysed product using SO2 at 1 to 15 wt % of dry mass, a temperature 125 to 350° C., a pressure of 0.5 to 4 MPa for 1 to 20 minutes,
   A5-S) hydrolysing the obtained the hydrolysed product using SO2 at 1 to 75 g/l and NH4OH, a pH 2 to 7, a temperature 90 to 250° C., a pressure of 0.1 to 2 MPa for 1 to 75 minutes,
   cleaning the hydrolysed product,
   L) Fermentation of the hydrolysed product comprising the steps of
      K-1) fermenting of hexose using yeast,
      K-2) fermenting of pentose using yeast, and cleaning the fermented liquid to obtain a solution of 90 to 98 vol % ethanol,
B) hydrothermal carbonizing/liquefaction a portion of the hydrolyzed material that is not further processed using hydrothermal liquefaction (HTL) or hydrothermal carbonization (HTC) to produce at least biooil,
wherein step B) comprises or consists of the steps
   B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
   B-2) temporizing the heated material obtained in step B-1) further to at least 300° C., or to 300 to 400° C., optionally using induction heating,
   B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa,
C) separating liquids, including oil, and gases from prior process steps for cleaning and reuse of liquid, gases and chemicals contained therein,
   wherein the process for oil cleaning comprises or consists of steps
   H-oil 1) transporting gases, liquid, oil for recycling for cleaning and recycling of gases, liquid, oil and chemicals contained therein,
   H-oil 2) cleaning the oil to separate coal from oil,
   H-oil 3) cleaning oil from ammonium/ammonia by scrubbing and or cleaning oil from sulfur containing compounds by scrubbing, whereby ammonium/ammonia and sulfur containing compounds are cleaned and reused in the process,
   H-oil 4) distilling the oil one or more times to obtain different fractions of, such as raw light biooil that can be used as fuel and raw heavy oil that can be used in asphalt,
   and whereby any gases produced during the oil cleaning process are transported and cleaned for further processing, and
D) generating electricity and/or steam to perform the steps of the process by using liquid, gas, biooil or bio-coal produced in the prior process steps, to operate at least a part of the steps of the process.

In some aspects, hydrolysing step A5) is done using SO2 at 1 to 10 wt % of dry mass, a temperature 150 to 300° C., a pressure of 1 to 2.5 MPa for 1 to 15 minutes. In some aspects, SO2 is added in the form of gas. SO2 may be added as mixture of air and SO2.

In some aspects, hydrolysing step A5-S) is done using SO2 at 1 to 50 g/l and NH4OH, a pH 2 to 7, a temperature 100 to 200° C., a pressure of 0.1 to 1 MPa for 5 to 60 minutes.

The process has an improved yield compared to known processes. The process of the invention provides a stable process with improved controllability of the different steps, which also improves flexibility in use of raw material. Any kind of starting material can be used, such as any herbaceous energy crops or short-rotation energy crops.

Hydrolysis step A5-S) is important for splitting poly- and di-saccharides into sugars. NH4OH used in the A5-S) prevents the decomposition of the sugars. This increases the yield in the process. NH4OH also prevents the formation of toxins, such as furfural from pentose. These toxins can be formed when SO2 hydrates into H2SO4. Due to the presence of NH4OH in step A5-S), this reaction is almost completely prevented. This again improves the efficiency of the fermentation. Compared to an enzymatic hydrolysis in step A5-S), the hydrolysis is less time and energy consuming. It is also cheaper and requires less investment costs.

Ammonium will bind to the fibers. It has been found that these ammonium bindings are used as a nitrogen source by the yeast and do not have any negative impact on the fermentation process.

Both ammonium, sulfites, sulfur and other chemicals can be recycled and reused.

### BRIEF DESCRIPTION OF THE DRAWINGS

The invention will now be explained more closely by the description of different embodiments of the invention and with reference to the appended figures.

FIG. 1a,1b show aspects of the invention and FIG. 1c shows different hydrolysis.

FIG. 2 shows another aspect of the invention with parallel hydrolysis.

FIG. 3a shows yet another aspect of the invention with impregnation, de-resination, NH4HSO3 hydrolysis followed by Na2CO3 hydrolysis.

FIG. 3b shows step B) and C) and D) in detail according to an aspect of the invention.

FIG. 4a shows an aspect of gas cleaning.

FIG. 4b shows an aspect of liquid and oil cleaning.

FIG. 5a,5b shows aspects of lignosulfonating and vanillin production.

FIG. 6 shows an aspect of ammonium recycling.

FIG. 7 shows an aspect of sulfite recycling.

FIG. 8a, 8b shows aspects of sodium carbonate production and chemical recycling.

FIG. 9 shows an aspect of DHS

FIG. 10 shows an aspect of MSF.

FIG. 11 shows an aspect of gas cleaning.

FIG. 12 shows a Chevron WWT-process.

### DETAILED DESCRIPTION OF VARIOUS EMBODIMENTS OF THE INVENTION

The present invention relates to an improved process for production of fossil free hydrocarbon products from lignocellulosic material.

The process of the invention comprises or consists of the steps of:
A) hydrolyzing the lignocellulosic material using ammonium bisulfite, whereby the conditions of the hydrolysis are being controlled by regulating pH, temperature, color, pressure, sulfite content, kappa number and/or R18, such that a desired product can be obtained for further processing of the hydrolyzed material,
B) hydrothermal carbonizing/liquefaction a portion of the hydrolyzed material that is not further processed using hydrothermal liquefaction (HTL) or hydrothermal carbonization (HTC) to produce at least biooil,
C) separating liquids, including oil, and gases from prior process steps for cleaning and reuse of liquid, gases and chemicals contained therein,
D) generating electricity and/or steam to perform the steps of the process by using liquid, gas, biooil or bio-coal produced in the prior process steps, to operate at least a part of the steps of the process.

In some aspects, the starting material is pretreated using cleaning steps E) and/or impregnations steps F).

In some aspects, the process is continuous.

The process of the invention has many advantages over the sulphate process. One advantage of the process of the invention is that almost all chemical substances can be extracted from lignocellulosic material to produce renewable products.

By adjusting the conditions for the hydrolysis, different types of lignocellulosic material can be used, and many different end products can be made, in contrast to known processes that cannot assimilate all the wood substances more than during combustion. In addition, the process of the invention may be performed in a closed systems, whereby the processes use water that comes in via the fresh lignocellulosic material is used. By using new and known process technology in a new manner, the necessary changes can be achieved, while reducing investment and operating costs without sacrificing productivity or product quality. The process of the invention allows the development of a modern and flexible process that can be implemented in a modern biorefinery.

There are several advantages in using ammonium in the sulfite and bisulfite hydrolysis processes of the invention. Cooking time is shorter compared to use of calcium, magnesium or sodium (bi) sulfite. The pH range for hydrolysis can be wider, which reduces the sensitivity of the hydrolysis for changes in pH during the cooking. More different type of starting material can be used, which improves the flexibility and efficiency of the process.

A higher purity or higher yield can be obtained in the final product using ammonium instead of using calcium, magnesium or sodium. This means brighter paper and tissues or higher yield in ethanol or biofuel after hydrolysis. Ammonium makes it possible to even use deciduous trees for the production of paper products or ethanol or biofuel. Ammonium can even be used as nutrient for yeast during fermentation. Ammonium can be produced in the process of the invention using hydrogen gas and nitrogen from the air or from other processes. Ammonium does not need to be made using fossil fuels. Ammonium can be recycled and reused, which reduces costs for chemicals in the different processes of the invention. Ammonium improves speed of hydrolysis.

Generally, about 20% of biomass is used as timber, 20% is used as paper mass and about 1% is used for biooil. The process of the invention allows an increased percentage of biomass to be used for production of bioproducts. By building a platform of different processes, where different modules can be coupled and work together, the resources from biomass can be utilized to a greater extent. An example of a module process may be fermentation of hydrolyzed biomass or bleaching for production of tissues.

With help of the platform process of the invention, about 95% of the biomass from the forest can be transformed into salable products. Greenhouse gas emission can be reduced by over 90%. The overall energy use can be reduced by at least 50%, while revenues increase by at least 30% due to increased sales of different products produced. Investment costs are relatively low because existing installations can be adapted and used.

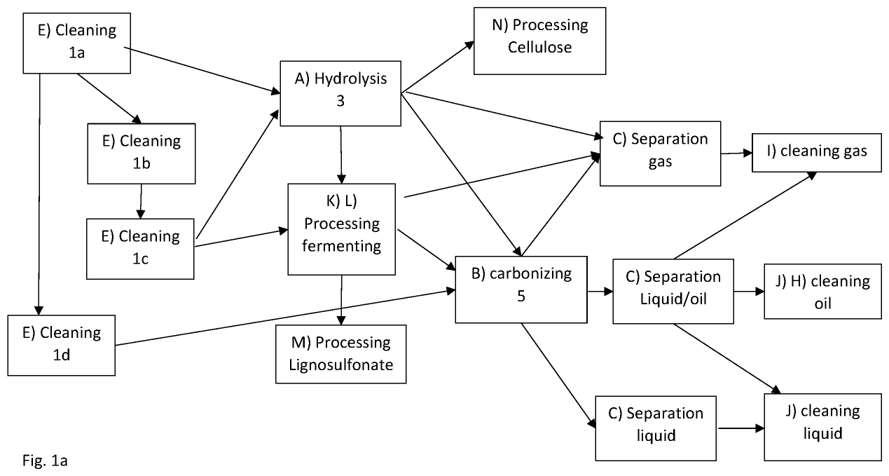

As shown in FIG. 1b, the process may comprise a further step G) of converting at least some of the gases and water produced from the different process steps, into synthetic hydrocarbon gas and water, using electrolysis, in for example a synthetic hydrocarbon production tank (ESH) 9. This step is preferably performed prior to step D) such that the produced synthetic hydrocarbons can be used for generating electricity and/or steam.

For electrolysis, a reversable solid oxide fuel cell (RSOFC) may be used as for example described in Nguyen Q, et al, The Electrochemical Society Interface, Water 2013, Reversable solid oxide fuel cell technology for green fuel and power production.

Electrolysis may be followed by a Fischer-Tropsch process for conversion of syngas into carbohydrates and water using a catalyst, such as iron. Electrolysis may also be followed by a Sabatier process for conversion of carbon dioxide and hydrogen into methane and water using a catalyst, such as nickel. A combination of the Fischer-Tropsch and Sabatier process may be used as well.

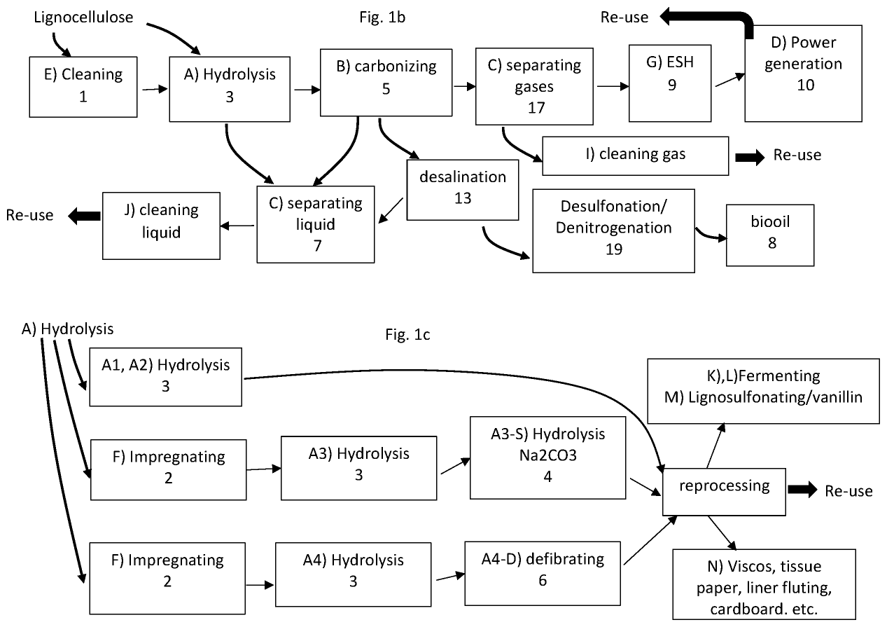

Prior to adding the hydrolyzed material to the HTL or HTC tank 5, the material may be mixed. This is especially important when using more than one hydrolysis and reprocessing steps in parallel as shown in FIG. 1-2.

Separation of liquid and solid material may be done at different stages during the process, for example prior to carbonizing the hydrolyzed material. Also, evaporating steps to remove a liquid phase, may be done at different stages during the process. In some aspects, the process is performed in a closed system in which no gases are being exhausted to the environment other than water vapor and/or biogenic carbon dioxide.

At least part of the hydrolyzed material is hydrothermally treated. This may be done using an HTL reactor 5 or an HTC reactor 5a.

In some aspects, hydrothermal carbonizing of the hydrolyzed material may be done by first heating the hydrolyzed material to a temperature between 25° and 350° C. for example using a heat exchange element, and then degassing the heated material using a degassing element, and subsequently hydrothermal carbonizing the degassed material in one or more hydrothermal liquefaction (HTL) reactor 5 at a temperature between 25° and 500° C. and a pressure of at least 15 or 20 MPa, to convert the hydrolyzed material into at least hydrocarbon biogas, water and biooil.

In some aspects, the hydrolyzed material is hydrothermally treated in one or more hydrothermal liquefaction (HTL) reactor 5 at a temperature between 325 and 400° C. and a pressure of at least 22.5 MPa.

In one aspect, oxygen is added during hydrothermal treatment to improve the HTL treatment.

Examples of suitable organic/lignocellulosic material may be herbaceous energy crops and short-rotation energy crops. Other waste, such as industrial and household waste can be used in the process of the invention. Hydrolyses combined with HTL or HTC reduces formation of char, tar and coke during hydrothermal treatment in a HT tank 5.

In some aspects, ammonium bisulfite is used for hydrolysis and an HTL reactor is used for hydrothermal treatment. An advantage of use of ammonium bisulfite is that more different types of biowaste can be used in the process. Further, less black cook residues are formed in the HTL reactor when ammonium bisulfite is used during hydrolysis. In some aspects, no screw is needed in the hydrothermal tank to prevent formation of black cook in the tank. By using ammonium bisulfite no further catalysts are needed for hydrolysis of lignocellulosic material. A further advantage is that ammonium bisulfite can be recovered from the process. This reduces overall process costs. It also reduces the impact of the process on the environment. No metal, such as calcium and magnesium are released to the environment.

The HTL and HTC treatments do not consume energy in the removal of water. Instead, water facilitates separation of the oily compounds from the more polar compounds. HTL and HTC are economically and process technically attractive.

Alternatively, in some aspects, hydrothermal carbonizing of the hydrolyzed material may be done by dehydrating the hydrolyzed material and hydrothermal carbonizing the material in one or more hydrothermal carbonization (HTC) reactor 5a at a temperature between 15° and 250° C. and a pressure between 2 and 5 MPa, to convert the hydrolyzed material into at least bio-coal, ammonium, lignin, sulfur and ashes.

The recycled water may be reused in the process, for example for hydrolysis. The biogas and biooil may be further processed by cleaning and fractioning of oil.

In some aspects, carbonization/liquefaction step B) comprises or consists of the steps
B-1) mixing starting material having a concentration of 45 to 65 wt %, or 50 to 60 wt %, or 54 to 56 wt %, in a heat exchanger b-2, whereby the starting material may be hydrolyzed material from step A1) to A5) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
B-2) temporizing the heated material obtained in step B-1) further to at least 300° C., or to 300 to 400° C., optionally using induction heating,
B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa, followed by
C) separating gas, liquid and oil in a separation tank c-7, whereby a portion of the liquid is transported to one or more heat exchanger b-2, and part of the liquid is transported to one or more cleaning tanks 20, 21, and whereby a portion of the gas and oil is burned to generate energy to perform any one of the processes and a portion of the gas and oil are transported to oil and gas cleaning tanks 8, 20, and followed by step D).

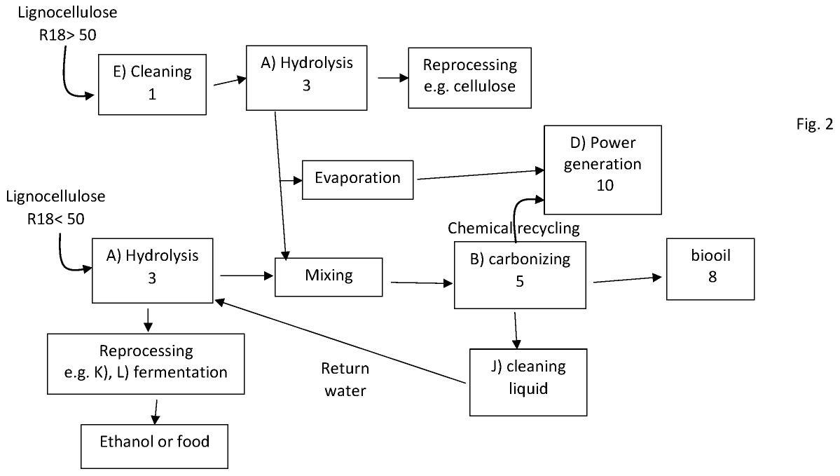

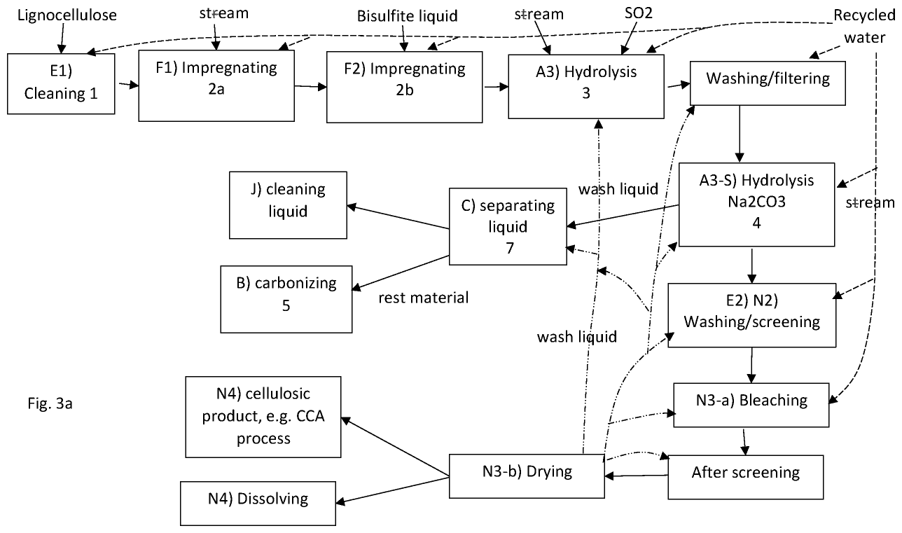

FIG. 3b shows an example of a module for the step B) process, whereby hydrolysed or residue material from other modules in the process are mixed and then pumped in pump b-1 to the heat exchanger b-2. This starting material may have a concentration of 45 to 65 wt %, or 50 to 60 wt %, or 54 to 56 wt %. This concentration is important to obtain a viscosity that allows the material to flow from the mixing tank b-0 through the pump to the heat exchanger b-2. In the heat exchanger, the material is mixed with liquid to obtain a mixture of material and liquid having a concentration of 25 to 45 wt %, or 30 to 40 wt %, or 34 to 37 wt % and a temperature of at least 250° C. Hot liquid from the separation tank is added to the heat exchanger. A pump b-3 may be used for this purpose. Any excess material may be transported back to the mixing tank b-0. This concentration is important to obtain the desired end product after carbonization. If the content of lignin in the material used in the HTL is too high, this may result in an increased amount of coal and thus impair the quality of biofuel produced from such coal, or if the content of lignin in the material used in the HTL is too low lignin content, this may increase the risk for byproduct formation in the HTL and thus decreases the energy-content of biofuel. A low lignin content in the HTL would also reduce the amount of chemicals that can be recycled.

Subsequently, the material is temporized in tank b-4 to increase the temperature to at least 300° C., or to 340 to 390° C. prior to entering the HTL. Induction heating may be used in tank b-4.

A pressure used for transporting the material through the system, especially from the heat-exchanger b-2 to the HTL may be at least 15 MPa, or 15 to 30 MPa, or 20 to 28 MPa. The pressure must ensure transport of the material but also be low enough to minimize transport costs.

From the HTL the material is enters the separation tank 7. Here the pressure and temperature are reduced and gases, oils and liquids are separated. A portion of the gas and liquids may be used in the power plant and a portion may be transported to cleaning tanks 8, 20. A portion of the liquid may be transported to the water cleaning tank 21. A portion of the liquid is pumped to other tanks used in the different processes, such as back to mixing tanks b-0, or to heat exchangers b-2. Wastewater from mixing tank b-0 may be added to the separation tank 7 as shown in FIG. 3b. Optionally the gas, oil and liquid from tank 7 are burned in an oven 7a prior to be cleaned.

The process as shown in FIG. 3b is flexible and easy to steer and adapt. The process re-uses energy, heat, liquids and chemicals to minimize overall cost of the system and to reduce the impact of the process on the environment.

Ammonium used in the hydrolysis can be used as a hydrogen donor during carbonization. In some aspects, no additional hydrogen donor needs to be added. Using NH4 as a solvent reduces the viscosity of the biooil produced, which improves the processability of the biooil. NH4 is a cheap solvent compared the lower alcohols used in known processes. NH4, NH3 is already present in the liquid. This simplifies the carbonization process and reduces costs. Lower alcohols, such a methanol and ethanol (obtained from fermentation process) may be added to the liquid to further improve the yield of carbonization. The pH of the material entering the HTL tank is preferably about 7 for optimum separation of phenolic compounds and water.

Sodium carbonate may be added as a catalyst during carbonization. Advantageously, hydrolysed material from step A3-S) already contains sodium carbonate. This reduces cost and time for the carbonization step B). If no sodium carbonate is present, this may be added prior to carbonisating the material. The concentration Na2CO3 may be 1 to 25 wt % or 5 to 20 wt % of the material that enters the HTL tank 5. Other catalysts may be added, such as NaOH, K2CO3, KOH. Na2CO3 has the advantage of improving the yield of the process for production of biooil. Less solid residues are generated during carbonization, i.e. condensation of lignin is reduced. Besides, by using Na2CO3, the quality of biooil obtained is improved. The biooil contain less oxygen and nitrogen, which improves the energy-content of the biooil. Furthermore, NH3, NH4, Na, CO2 and CO3 can be separated after carbonization and recycled into the process. This reduces overall cost for chemicals and improves the environmental friendliness of the process.

The temperature in the HTL is preferably between 34° and 380° C. Below 340° C. the yield for biooil is reduced. Above 380° C. more unwanted by products and less organic compounds and thus less biooils are produced. Also, the amount of coal is increased. The yield of biooil is about 80% using ammonium and ammonia as a solvent together with sodium carbonate as a catalyst and at a temperature between 34° and 380° C.

The time used for carbonization is at least 15 or 20 minutes depending on the origin of the starting material and the desired product to be produced. Using more than 30 minutes increases the costs for carbonization, while the yield does not significantly increase further. A maximum time of 30 minutes minimized energy costs.

The energy generated in the HTL is reused in the process, which again minimized energy costs of the overall process. The coal produced in the HTL tank may be used as filters, as catalysts or as fuel. The biooil produced is preferably mixable with fossil oil. This improves its useability in many applications. In some aspects, the biooil produced by the process of the invention comprises or consists of 90 to 99 wt % methylated phenols. In some aspects, the presence of metylfenyleter eller metoxibensen in the biooil produced according to the process of the invention is less than 1 wt %.

### Cleaning Wood

In some aspects, the chips of biomass or wood used in step 1 are pieces of biomass or wood.

As shown in FIG. 1a, the biomass may be mechanically treated (1a) prior to use of the material in the process of the invention. Precleaning may further comprise removal of bark and cutting (1b), and/or cutting and sorting sawdust and chips (1c) and/or washing and cutting biowaste from food industry or households.

The chips of biomass may have a size of about 100, 50, 25, 15, 10, 5 or 1 cm or less.

This size allows the use of basically any type of raw material, such as any hard- or softwood. Sawdust and other left-over products can be used in the process of the invention.

The size also minimized the time needed to process the material. This in turn reduces energy costs for the overall process. The size of the chips also reduces the amount of chemicals and water needed to process the biomass.

A steaming step E1), F1) may be included prior to hydrolysis. The temperature may be between 80 to 120, or 90 to 110° C. Steaming may be done for 1 to 30, or 1 to 20, or 1 to 15, or 1 to 10, or 1 to 5 minutes. The pressure may be atmospheric (0.1 MPa). The chips of biomass may than be transported into one or more subsequent processes, such as A). As shown in FIG. 1a, the cleaned material can be further processed in hydrolysis A), whereafter the material can be re-processed for production of cellulosic products N) or for production of alcohols, lignosulfonate) K), L), M), and/or the biomaterial can be carbonized/liquefaction in a HTL or HTC tank 5 in step B),
Gases, liquids including oil are separated in step C) and subsequently cleaned for recycling chemical compounds contained therein.

The process may further comprise units or tanks for generating electricity and/or steam in step D) to perform the steps of the process by using liquid, gas, biooil or bio-coal produced in the prior process steps, to operate at least a part of the steps of the process.

As explained below, through connecting the different module-processes with each other, and thus recycling energy and chemicals, the overall process of the invention has a reduced use of energy, reduced use of new chemicals and an improved overall yield. Also, the carbon foot-print of the overall and different module-processes is reduced.

### Chemical Material Treatment

In some aspects, the wood chips of biomass or wood used in step 1 are pieces of biomass or wood having a maximum length/diameter of 15 cm, or 10 cm. The biomass may be mechanically treated/chopped prior to use of the material in the process of the invention.

### Resin Removal and Control, Step E)

In some aspects, as shown in FIG. 3, a cleaning step E) is performed to remove resin present in the lignocellulosic material comprising or consisting of the steps of:
E1) treating wood chips with hot air at a temperature from 30 to 90° C. or 40 to 80° C. to accelerate resin maturation,
E2) filtering and fractioning the hydrolyzed material to remove a remaining resin, whereby hydrolysis is performed between steps E1) and E2).

In some aspects, mechanical treatment is done prior to step E1).

By combining two resin steps, the resin content can be measured in real time and the resin content in the final product can be controlled.

In step E1), the wood chips may be transported to the top of a tank 1 where the chips are fed. From the bottom of the tank, hot air is blown in, such that the temperature is steady at 50 to 70 or 60° C. The air passes through the wood chips to regulate the temperature in the chips in order to establish a so-called accelerated resin maturation process in the chip pieces. The time needed can vary between 24 to 72 hours depending on the degree of resin maturity desired and the type of lignocellulosic material used.

In some aspects, the process step E1) is continuous, i.e. the wood chips are fed into the top of tank 1 and removed from the bottom of the tank, continuously.

In some aspects, in process step E2), the hydrolyzed material from step A) is sieved one or more times, washed and dewatered. Then, the resin content of the pulp is measured, and the consistency of the pulp determined prior to fiber fractionating. 0-15% of the resin can be fractionated by adjusting the consistency of the pulp (water content) in a washing filter and adjusting the speed of the wire and pressure in a resin removal filter. Two or more filters may be used. In some aspects, one or more vertical filters in a hermetically sealed tank are used to prevent gases from entering the environment. These gases may be recycled in the process of the invention.

Resin from both parenchyma and channels can be removed.

Based on product specification, type, condition and annual variations of lignocellulosic material, the amount of resin in the end-product can effectively and continuously be controlled by measuring the resin content and water content in the washing step before using the resin removal filter. The time needed for step E1) of the resin maturation process can be continuously adjusted and in step E2) the water content, the speed of the wire and the pressure on the press can be continuously adjusted.

Cleaning steps E1) and E1) plus E2) improve the yield of the overall process. The process allows the resin to be removed almost completely at minimum fiber loss (2-3 wt % versus about 6 wt % using alkali treatment or mechanical treatment for removal of resins). The cleaning steps also allow the use of leave trees and thus improve the flexibility of use of different starting materials in the process. Further, the useful chemicals present in the resin can now be isolated, which improved the yield and revenue of the process. The cleaning process allows to steer the amount of resin in the material used in subsequent processes within very narrow ranges. The cleaning processes improve the processability, such as control of the subsequent processes. The products, such as material used for paper production is cleaner compared products, where wood has been cleaned from resin using alkali treatment or mechanical treatment. The cleaning process allows to use the process of the invention continuously and prevent black cook and other degeneration of the starting material during hydrolysis. The cleaning improves delignification and reduces the brittleness of the final paper products. Besides, by heating the starting material, less energy is needed for heating the material in the next step, which reduces the overall energy costs. Additionally, the process of the invention reduces sewage problems known to processes using mechanical or alkali treatment. Instead, all liquids and raw material obtained by the cleaning process are used in subsequent processes. This reduces the carbon-foot print of the processes.

### Impregnating Start Material, Step F)

In some aspects, as shown in FIG. 3, an impregnation step F) is performed prior to hydrolysis comprising or consisting of the steps of:
F-1) steaming the wood chips at a temperature of 60 to 200° C. or 80 to 150° C. at a pressure of 0.1 to 1 MPa or 0.1 to 0.5 MPa during 1 to 30 minutes, or 1 to 15 minutes,
F-2) pre-hydrolyzing the material obtained in step F1) using ammonium sulfite or ammonium bisulfite at a pH of 4 to 7, a temperature of 70 to 170° C., or 80 to 150° C., a pressure of 0.1 to 3 MPa or 0.1 to 1.5 MPa for 1 to 300 minutes, or 5 to 250 minutes.

The starting material may be chips of lignocellulosic material or lignocellulosic material that has been treated in step E1).

In some aspects, it may be important to completely impregnate the wood chips prior to hydrolysis. Especially in a continuous hydrolyzation process, a poor impregnation may reduce the breaking down of the lignocellulosic material during hydrolysis or reduce defibration of the wood chips, which may reduce the yield of the hydrolysis steps.

In some aspects, the wood chips in step F1) are added to a steam-basing reactor 2a. The wood chips may be steamed at a temperature of 80 to 150° C. and a pressure of 0.1 to 0.5 MPa for 1 to 15 minutes to remove air and other non-condensable gases (NCG), which may make it difficult for the hydrolysis chemicals to penetrate the wood chips.

Step E-1, and steaming step F-1) is important for opening the cells in the biomass. Steaming allows air bound in the biomass to be removed. Steaming therefore improves the effectiveness and efficiency of the hydrolysis in step A). The use of the steaming step reduces water and energy consumption in the subsequent steps of the process, especially in hydrolysis steps F-2) and A).

Steaming step F-1) improves delignification and reduces brittleness in the final paper product. By heating the starting material, the next step F-2) can be performed quicker, which saves time and energy for the overall process. This step F-1) also prevent or minimized degeneration of the material during hydrolysis, thereby minimizing black cook and improving the yield of sugars, lignin and cellulose. The forming of toxins, such as furfuryl is reduced using this steaming step F-1). Further, the steaming step allows use of a variety of starting materials, which improves the flexibility of use of starting material for the process. In some aspects, the wood chips in step F2) are added to an impregnation reactor 2b, for example at a top of the reactor and heated in an ammonium bisulfite liquid at a pH of 4 to 7 at a temperature of 80 to 150° C. and a pressure of 0.1 to 1.5 MPa for 5 to 250 minutes. When the impregnation is completed, the impregnated chip pieces may be taken out at the bottom of the reactor 2b. A thermal stable cook can be established, where mixing of material at different stages of the hydrolysis is prevented. This reduces decomposition/degeneration of the starting material and improves the yield of the process.

In some aspects, step F-2) is done using NH4HSO3, a pH 3 to 7, a temperature 80 to 250° C., atmospheric pressure for 5 to 360 minutes. In some aspects, step F-2) is done using NH4HSO3, a pH 3 to 7, a temperature 100 to 200° C., atmospheric pressure for 10 to 240 minutes.

The use of NH4HSO3 further improves the release of sugars from the biomass and reduces time needed for hydrolysis. Step F-2) prevents or minimized the forming of CaSO4, thereby reducing corrosion. Step F-2) also improves the effectiveness and efficiency of the hydrolysis in step A). Lignosulphonate is produced during step F-2). This product has a high market value, which sales reduce the overall costs of the process. Furthermore, step F-2) reduces formation of toxins during further processing of the biomass. Toxins inhibit fermentation. Step F-2) improves delignification. In some aspects, the impregnation steps F1) and F2) are performed continuously.

### Hydrolysis, Step A)

### Step A1)

The hydrolysis may be performed in different ways as shown in FIG. 1c.

In some aspects, the hydrolyzing step A) is performed using the step of A1) hydrolyzing the lignocellulosic material using ammonium bisulfite at a temperature between 80 and 200° C. for a period of 0.5 to 36 hours and at a pressure between 0.1 and 1.5 MPa.

For lignocellulosic material having a low energy content, such a low cellulose and sugar content, or material having an R18 below 50, the material may be hydrolyzed and subsequently carbonized. The temperature in such a process may be higher and the pH range can be wider, e.g. from 1 to 13.

Even for material containing sugar, the hydrolysis step may be performed at higher temperatures for subsequent fermentation of the hydrolyzed material into alcohol or food products.

Especially in parallel hydrolysis, one of the hydrolysis step A may be performed by heating the material to be hydrolyzed and adding an acidic liquid comprising or consisting of a sulfide source, such as (NH₄)₂S, (NH₄)₂SO₄, SO₃²⁻, S² or S. In one aspect, ammonium sulfite is (also) used, and the pH is between 1.5 and 2.5 at a temperature between 10° and 150° C.

### Step A2)

In some aspects, the hydrolyzing step A) is performed using the step of
A2) hydrolyzing the lignocellulosic material using ammonium bisulfite at a temperature of 125 to 170° C., a pH of 4 to 7 for 2 to 6 hours and a liquid/material ratio of 2.5 to 4.5, at a pressure from 0.1 to 3, or 0.1 to 1 MPa.

In some aspects, a cleaning step E) is performed to remove resin present in the lignocellulosic material, wherein the hydrolyzing step A) is performed using the steps comprising or consisting of:
E1) treating wood chips with hot air at a temperature between 4° and 80° C. to accelerate resin maturation,
then hydrolyzing the obtained material in step A2) using ammonium bisulfite at a temperature of 125 to 170° C., a pH of 4 to 7 for 2 to 6 hours and a liquid/material ratio of 2.5 to 4.5 and at a pressure from 0.1 to 3, or 0.1 to 1 MPa, followed by
E2) filtering and fractioning the hydrolyzed material to remove a remaining resin.

In some aspects, an impregnation step F) is performed prior to hydrolysis, wherein the hydrolyzing step A) is performed using the steps comprising or consisting of:
F-1) steaming the wood chips at a temperature of 80 to 150° C. at a pressure of 0.1 to 0.5 MPa during 1 to 30 minutes, or 1 to 15 minutes,
F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min.

In some aspects, a cleaning step E) and an impregnation step F) is performed wherein the hydrolyzing step A) is performed using the steps comprising or consisting of:
E1) treating wood chips with hot air at a temperature between 4° and 80° C. to accelerate resin maturation,
F-1) steaming the wood chips at a temperature of 80 to 150° C. at a pressure of 0.1 to 0.5 MPa during 1 to 30 minutes, or 1 to 15 minutes,
F-2) pre-hydrolyzing the material obtained in step F1) using ammonium sulfite at a pH of 7 to 9, a temperature of 130 to 190° C., a pressure of 0.1 to 1.5 MPa for 0.5 to 2 hours,
then hydrolyzing the obtained material in step A2) using ammonium bisulfite at a temperature of 130 to 170° C., a pH of 4 to 6 for 0.5 to 4 hours, at a pressure from 0.1 to 3, or 0.1 to 1 MPa followed by
E2) filtering and fractioning the hydrolyzed material to remove a remaining resin.

This hydrolysis step A2) is especially useful for further processing of the material into electricity isolating paper or grease proof paper.

The yield was from 60 to 70 wt %, and the pulps was easy to grind and had insulating ability, i.e. the paper did conduct electricity.

### Step A3)

In some aspects, the hydrolyzing step A) is performed using the step of
A3) hydrolyzing the lignocellulosic material using ammonium bisulfite at a temperature of 125 to 170° C., a pH of 4 to 7 for 2 to 6 hours and a liquid/material ratio of 2.5 to 4.5, at a pressure from 0.1 to 3, or 0.1 to 1 MPa, and
A3-S) hydrolyzing the obtained material in step A3) using sodium carbonate (20 to 35 wt %) at a temperature of 100 to 200° C., a pressure of 0.1 to 1 MPa for 0.5 to 4 hours,

In some aspects, a cleaning step E) is performed to remove resin present in the lignocellulosic material, wherein the hydrolyzing step A) is performed using the steps comprising or consisting of:
E1) treating wood chips with hot air at a temperature between 4° and 80° C. to accelerate resin maturation,
then hydrolyzing the obtained material in step A3) using ammonium bisulfite at a temperature of 125 to 170° C., a pH of 4 to 7 for 2 to 6 hours and a liquid/material ratio of 2.5 to 4.5, at a pressure from 0.1 to 3, or 0.1 to 1 MPa and
A3-S) hydrolyzing the obtained material in step A3) using sodium carbonate (20 to 35 wt %) at a temperature of 100 to 200° C., a pressure of 0.1 to 1 MPa for 0.5 to 4 hours, followed by
E2) filtering and fractioning the hydrolyzed material to remove a remaining resin.

In some aspects, a cleaning step E) and an impregnation step F) is wherein the hydrolyzing step A3) is performed using the steps comprising or consisting of:
E1) treating wood chips with hot air at a temperature between 4° and 80° C. to accelerate resin maturation,
F-1) steaming the wood chips at a temperature of 80 to 150° C. at a pressure of 0.1 to 0.5 MPa during 1 to 30 minutes, or 1 to 15 minutes,
F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min,
then hydrolyzing the obtained material in step A3) using ammonium bisulfite at a temperature of 125 to 170° C., a pH of 4 to 7 for 2 to 6 hours and a liquid/material ratio of 2.5 to 4.5, at a pressure from 0.1 to 3, or 0.1 to 1 MPa and
A3-S) hydrolyzing the obtained material in step A3) using sodium carbonate (20 to 35 wt %) at a temperature of 100 to 200° C., a pressure of 0.1 to 1 MPa for 0.5 to 4 hours, followed by
E2) filtering and fractioning the hydrolyzed material to remove a remaining resin.

In some aspects, only an impregnation step F) is performed prior to hydrolysis.

This hydrolysis step A3) is especially useful for further processing of the material into cellulosic materials such as paper.

The second hydrolysis step A3-S) after the bisulfite hydrolysis is an extension of the hydrolysis process and at the same time functions as an alkali refining process to replace the alkaline and chlorine dioxide step in a bleaching step to produce advanced dissolving compositions with TCF bleaching. This step A3-S) uses sodium carbonate, which is recyclable and not toxic in other processes, which prevents cellulose degradation, efficient delignifies, and hydrolyses hemicellulose and can control the viscosity and degree of refinement of the pulp.

In a continuous process, a steam phase reactor 3 is used. Steam phase reactors are an established product on the market for the sulphate process and can with advantage also be used for bisulfite hydrolyses after certain modifications based on the special process properties that bisulfite hydrolysis creates.

In the steam phase reactor 3, a direct steam may be added to the top of the reactor that forces a downward movement of wood chips and digester liquid, with the “steam pad” in the top of the reactor above the wood chip and liquid level. The wood chips are hydrolysed with the added intermediate pressure steam and free SO2 comes into direct contact with the chips. The high-pressure layer maintains the pressure at a higher level in the reactor 3 than in the impregnation reactor 1.

The hydrolyzed wood chips may be entered to a top separator on a top of the reactor 3, which makes it possible to have a gas phase at the top of the reactor and at the same time a liquid phase at hydrolysis temperature from the beginning in the area directly below the top of the reactor. The liquid/wood ratio of the reactor can be selected so that the free liquid in the reactor has a sufficient downward velocity to avoid back-mixing in the tank. This means that a lower liquid/wood ratio can be used in the reactor if the hydrolysis process is sufficiently stable. In the process of the invention, even at very low liquid/wood ratio (1 to 3) for a continuous hydrolysis, the hydrolysis is usually done completely in the liquid phase.

The hydrolysis has been carried with ammonium bisulfite at a pH of 4 to 7, at a temperature of 125 to 170° C., with a liquid:wood ratio of 2.5 to 4.5, for 2 to 6 hours. The ISO brightness, tear factor, chlorine number, carbohydrates, lignin, additives, hydrolysis yield, R18 value can be measured. The ISO brightness measurement system quantifies the actual percentage of light reflected from a sample at 457 nm.

The hydrolysis had a yield of 56 wt %, with a chlorine number of 6.5, kappa number of 32.5, R18 value of 85. The tear factor was 81 to 106 and the brightness 62 to 68 depending on the liquid:wood ratio.

Under these conditions, a qualitative material during stable bisulfite hydrolysis was obtained, which can be further refined in a subsequent soda step A3-S) in tank 4.

It is well documented that there is no gain from producing a hydrolyzed material having a chlorine number lower than 6.5, and a kappa number lower than 32 to obtain qualitative dissolving material after soda step A3-S). This is to prevent ending up with a coke acid precipitate with lignin condensation and subsequent black cook.

Preferably, prior to adding the material to reactor 4, the material is blown into a blow pit and pumped through a washing filter, where the chemicals from the bisulfite hydrolysis are washed out and sodium carbonate, Na₂CO₃ (soda) is added to the washing filter. The material is then pumped to the top of the reactor 4.

The hydrolyzed bisulfite material with a kappa number of 30 to 40 has been treated in different process conditions with sodium carbonate at a concentration of 20 to 35 w/w %, at a temperature of 100 to 200° C., at a pressure of 0.1 to 1 MPa, for 0.5 to 4 hours. The product obtained had a chlorine number of 1.5 to 2 with an R18 value of over 95, and a wood yield of 40-43% before bleaching.

After hydrolysis step A3), the material was fiber fractionated and bleached with both peracetic acid and hydrogen peroxide or with only hydrogen peroxide steps.

The products had a 90 ISO (92-93 ISO) brightness, and a viscosity of 40 to 60 cPT with an R18 value of over 90, where the resin content was within a narrow limit of 0.15 to 0.25 wt % for softwood pulp, while the leaf pulp had a limit of 0.5 wt % in the tests. This is probably because of inadequate resin maturation of the hardwood chips.

The hydrolysis was not disturbed by entered the soda step A3-S), but instead gave slightly better R18 values.

Also, the hydrolyzed material had an increased cellulose contents, at increased temperature and at increased alkalinity after the alkalization step A3-S), while the corresponding treatment of sulphate pulp cannot increase the cellulose content in the same way.

### Step A4)

In some aspects, the hydrolyzing step A) is performed using the step of
A4) hydrolyzing the lignocellulosic material using ammonium bisulfite at a temperature of 70 to 170° C., a pH of 3 to 7 a pressure of 0.1 to 1.2 MPa, for 0.5 to 6 hours and a liquid/material ratio of 2.5 to 5, and
A4-D) defibrating and/or beating the obtained material in step A4), and
optionally A4-Df) removing fine material, and
optionally, A4-R) adding recycled paper material to the defibrated material in step A4-D).

The yield of this hydrolysis process was from 65 to 95 wt % with a chloride number of 14 to 32.

In some aspects, a cleaning step E) is performed to remove resin present in the lignocellulosic material, wherein the hydrolyzing step A) is performed using the steps comprising or consisting of:
E1) treating wood chips with hot air at a temperature between 4° and 80° C. to accelerate resin maturation,
then hydrolyzing the obtained material in step A4) using ammonium bisulfite at a temperature of 70 to 170° C., a pH of 3 to 7 a pressure of 0.1 to 1.2 MPa, for 0.5 to 6 hours and a liquid/material ratio of 2.5 to 5, and
E2) filtering and fractioning the hydrolyzed material to remove a remaining resin,
A4-D) defibrating and/or beating the obtained material in step A4), and
optionally A4-Df) removing fine material, and
optionally, A4-R) adding recycled paper material to the defibrated material in step A4-D).

In some aspects, a cleaning step E) and an impregnation step F) is performed wherein the hydrolyzing step A) is performed using the steps comprising or consisting of:
E1) treating wood chips with hot air at a temperature between 4° and 80° C. to accelerate resin maturation,
F-1) steaming the wood chips at a temperature of 80 to 150° C. at a pressure of 0.1 to 0.5 MPa during 1 to 30 minutes, or 1 to 15 minutes,
F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min,
then hydrolyzing the obtained material in step A4) using ammonium bisulfite at a temperature of 70 to 170° C., a pH of 3 to 7 a pressure of 0.1 to 1.2 MPa, for 0.5 to 6 hours and a liquid/material ratio of 2.5 to 5, and
E2) filtering and fractioning the hydrolyzed material to remove a remaining resin,
A4-D) defibrating and/or beating the obtained material in step A4), and
optionally A4-Df) removing fine material, and
optionally, A4-R) adding recycled paper material to the defibrated material in step A4-D).

In some aspects, only an impregnation step F) is performed prior to hydrolysis.

The temperature in hydrolysis step A4) may be 100 to 190° C. The defibration takes place immediately after hydrolysis in a so-called hot defibration at a temperature from 100 to 190° C. The energy input may be between 50-1000 kwh/ton pulp.

After hydrolysis, the pulp is defibrated in refiners 12 immediately after hydrolysis. This can be done with the remaining liquor during a process called thermo or hot refining. Alternatively, the hydrolyzed material is washed in a washing filter and then diluted with water. The consistency of the pulp may be from 3 to 45% and the temperature from 0 to 200° C., where the defibration takes place with a power range of 50 to 1500 kwh/ton pulp. This allows for the production of a number of different pulp qualities in high yield with low energy consumption.

This hydrolysis process A4) is especially useful for further processing of the material into cellulosic materials, such as tissue fluting, liner, cardboard, corrugated board and the like.

### a) Tissue and Other Soft Paper

The resulting bleachable high-yield bisulfite pulps has shown good performance for various tissue applications from both hardwood and softwoods.

When recycled fiber is mixed into the pulp, an improved performance is obtained in that the final product is less brittle.

It was found that the pulp was easily bleached in hydrogen peroxide up to 85% ISO brightness.

### b) Liner

The final product as liner showed no brittleness in a dry environment.

### c) Fluting.

Fluting is an intermediate layer in a corrugated board where the top and bottom are liners. This type of paper is normally made from deciduous trees in a semi-chemical neutral sulfite process.

Under certain process conditions, however, a semi-chemical bisulfite pulp may exhibit obvious advantages over a neutral sulfite pulp produced.

In the process of the invention using hydrolysis step A4), the yield of the process is increased from 70-75% to 80-85% with small variations. The material is suitable for fluting using hardwood as raw material with similar or better properties as from a sulfite process. Recycled fibers were mixed into the pulp, which had good paper properties.

In some aspects, the hydrolysis is performed continuously. In other aspects, all steps are performed continuously. In some aspects, two or more hydrolysis steps A1 to A5 are performed in parallel.

In some aspects, diffusors are used to separate liquid from mass. As shown in FIG. 3a, tank 7 may be a diffusor.

In some aspects, filters/sieves are used to separate mass from liquids/solutions. Filtering may be combined with washing. In some aspects, a twig filter is used after cleaning step E1) or impregnation step F-1). The reject from the sieve can be used in hydrolysis for further processing in for example fermentation.

Two or more filters may be used to separate fine particles from larger particles.

Diffusors and filters improve recycling of chemicals as well as washing of the intermediate and final products. They also improve drying of mass and thus make the overall process more efficient.

### Cleaning and Recycling or Reuse of Gases, Liquids and Chemicals

In some aspects, gases from prior process steps are separated in step C) and cleaned using water scrubbing to remove at least carbon dioxide, sulfate, hydrogen sulfide, ammonia and methane, whereby water used during scrubbing is transported for further cleaning.

In some aspects, liquids from prior process steps are separated in step C) and cleaned using multi-stepp Flash distillation (MSF), multiple-effect destillation (MED) or sour water stripping (Chevron WWT).

Production of chemicals is done through recycling of chemicals used and produced during the different processes of the invention. Chemicals may also be produced in separate modules of the process by using products/intermediates, heat, water from other processes in other modules. Step C) may thus comprise numerous modules for production or cleaning/recycling of chemicals. The production of the process-chemicals can flexible be adapted depending on the need of the chemical in other processes. Alternatively, chemicals may be produced for sales of the chemical. This improves the flexibility of the process of the invention. The following products may be produced in module processes comprised in step C); ammonium bisulfite, ammonium sulfite, ammonium carbamate ([NH4] [H2NCO2]), urea (NH₂CONH₂), cyanuric acid (C₃N₃(OH)₃ or (CO)₃(NH)₃), hydrogen peroxide (H₂O₂), acetic acid (CH₃COOH), peracetic acid (CH₃CO₂OH), acetic acid anhydride (CH3CO)2O, acetaldehyde (CH₃CHO), (supercritical) carbon dioxide, ethyl acetate (CH₃COOCH₅), ethylene oxide (C₂H₄O), ethene, propylene oxide (C₃H₆O), sodium percarbonate (2), sulfuric acid (H₂SO₄), polyols, such as polyethylene oxide or polyethylene glycol (PEG), polypropylene glycol (PPG) and Polytetrahydrofuran or PTMEG, and the like.

### Soda/Salt Wash

Oil purification may be done in three steps after the HTL process. The first step is separating water and gases from the oil. The next two steps are washing off salts/soda and then removing sulfur and ammonia. The oil purification has two primary goals, recycling chemicals and increasing the quality and sales value of the oil. Oil purification from soda and salts takes place after HTL and subsequent water separation. The washed-out substances end up in a water phase to be processed in the water cleaning.

A desalinator 13 is a process unit that removes salt from the crude oil.

The salt is mostly dissolved in water in the crude oil, not in the crude oil itself. Desalination is usually the first process in refining crude oil. The salinity after desalination is usually measured in PTB-kilograms of salt per thousand barrels of crude oil. Another specification is (BS&W).

The salts most commonly found in crude oil are calcium, sodium and magnesium. If these compounds are not removed from the oil, several problems may arise in the refining process.

The high temperatures that occur downstream in the process can cause hydrolysis, which in turn allows the formation of corrosive hydrochloric acid.

Inorganic pollutants in raw biooil cause deposits on heat exchangers and may lead to clogging and foul-smelling gases. Sodium, arsenic and other metals can poison catalysts in subsequent steps. It is thus important to remove the suspended solids and prevent problems in the process thus upgrading the quality of the bio-crude oil and at the same time recycling the chemicals to the process.

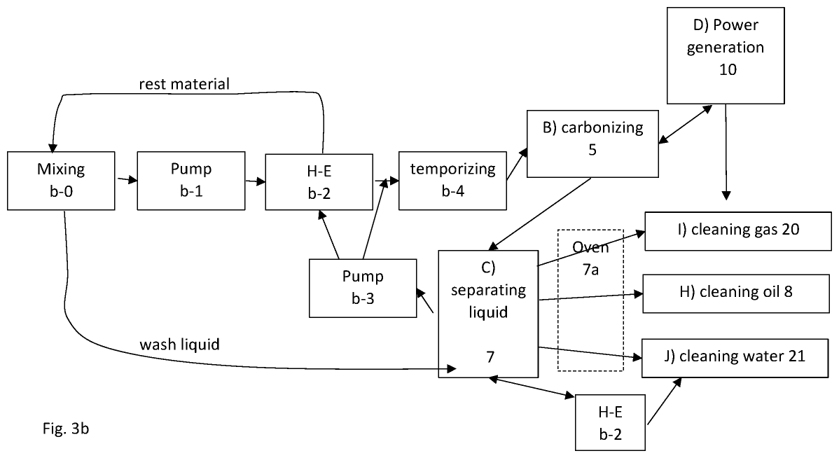

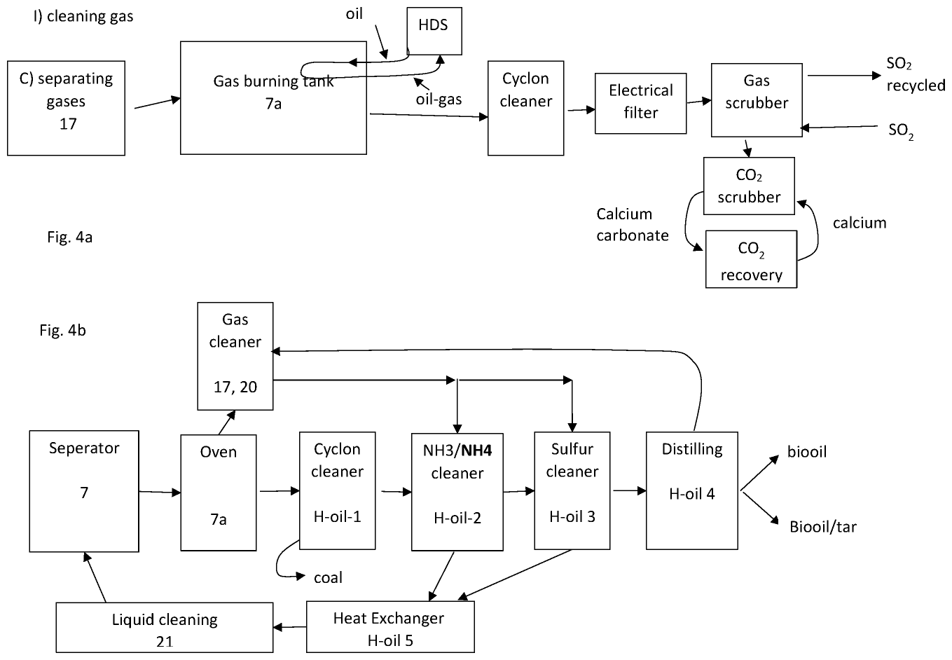

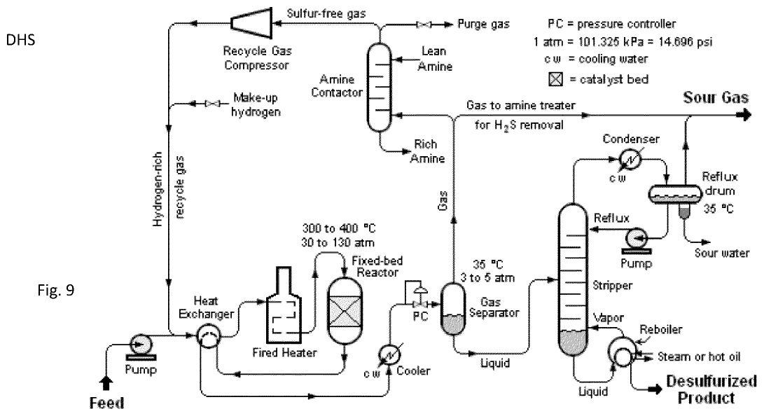

Crude oil to be desalinated may be heated to a temperature of 100 to 150° C. and mixed with 4-10% fresh water, which dilutes the salt. The mixture may then be pumped into a sedimentation tank, where the salt water is separated from the oil and separated. An electrostatic field may be applied by electrodes in the sedimentation tank, which induces polarization of the water droplets. This results in the water droplets clumping together and settling at the bottom of the tank. The extracted salt water may be processes for water cleaning together with the acidic water from chemical recovery. The desalinated bio-crude oil may then proceed to further cleaning, where further purification of the bio-crude oil takes place and where sulfur and ammonia may be extracted from the oil into a gas and water phase and which can be led to gas and water cleaning processes, where chemical recycling is desired. See FIGS. 4 and 9.

In some aspects, raw biooil is desalted/cleaned by a process comprising or consisting of the steps of
H1) mixing oil with 2 to 4 w/w % water and heating the mixture at a temperature of 90 to 200° C.,
H2) separating water and oil, optionally by applying an electrical field to polarize the water,
H3) extracting water.

### Hydrodesulfurization (HDS)

Hydrodesulfurization is a catalytic chemical process that is widely used to remove sulfur(S) but nitrogen (N). Purposes of HDS are removing sulfur, reducing the amount of sulfur dioxide (SO₂) in the oil, increasing quality and sales value of the oil and at the same time removing nitrogen in the form of ammonia (NH₃), which can be returned to the process. An HDS unit is also often referred to as a WWT Waste Water Treatment.

### Process Chemistry

Hydrogenolysis results in the cleavage of C—X bond, where C is a carbon atom and X is a sulfur(S), nitrogen (N) or oxygen (O) atom. The result of a hydrogenolysis reaction is the formation of CH and HX chemical bonds. Hydrodesulfurization is thus a hydrogenolysis reaction.

A desulfurization reaction may be performed in a fixed bed reactor at elevated temperatures of 300 to 400° C. and elevated pressures of 3 to 14 MPa, typically in the presence of a catalyst consisting of an alumina base impregnated with cobalt and molybdenum (CoMo-catalyst). Sometimes a combination of nickel and molybdenum (NiMo) is used, in addition to the CoMo-catalyst, for specific difficult-to-treat feed materials, e.g. containing high levels of chemically bound nitrogen. The bio-oil from an oil separator after the HTL process may be pumped up to a desired elevated pressure and combined with a stream of hydrogen-rich recycled gas. The resulting liquid-gas mixture may be preheated by flowing through a heat exchanger. The preheated oil mixture may then flow through a fired heater, where the feed mixture may be completely evaporated and heated to the required elevated temperature before entering the reactor and flow through a fixed bed of catalyst, where the hydrodesulfurization reaction takes place. The hot reaction products may be partially cooled by flowing through the heat exchanger, where the reactor feed may be preheated and then flow through a water-cooled heat exchanger before entering a pressure regulator (PC) undergoing a pressure reduction down to about 0.3 to 0.5 MPa. The resulting mixture of liquid and gas may enter the gas separator vessel at about 35° C. and a pressure of 0.3 to 0.5 MPa.

In some aspects, hydrodesulfurization of biooil is performed by a process comprising or consisting of the steps of
H4) contacting the oil, or desalted oil from step H1-H3) with a fixed bed reactor at elevated temperatures of 250 to 450° C., at a pressure of 3 to 14 MPa, optionally in the presence of a catalyst.

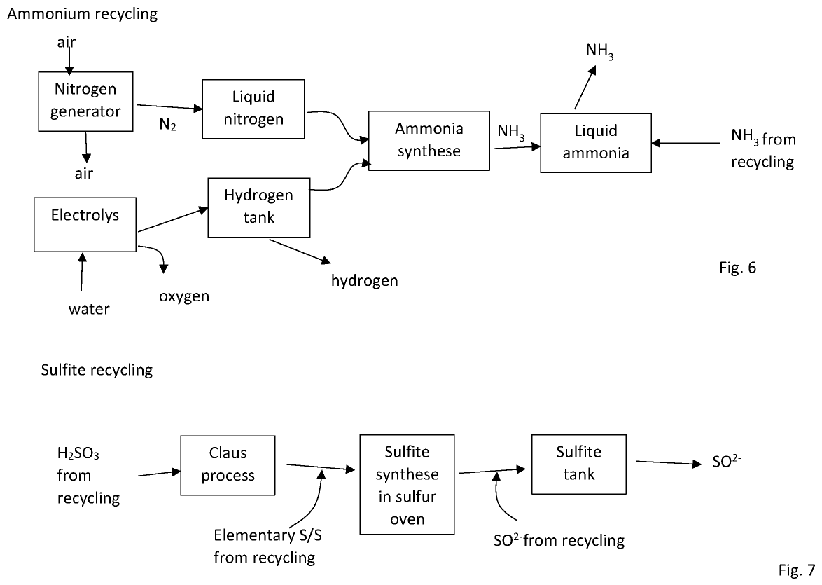

Most of the hydrogen-rich gas from the gas separator vessel may be recycled, which can be passed through an amine contactor to remove the reaction product H₂S. The H₂S-rich gas may be recycled for reuse in the process. The liquid from the gas separator may be directed through a reboiled stripper distillation tower. The bottom product from the stripper is the final desulfurized liquid product from the desulfurization unit. The acid gas from the stripper may contain hydrogen, methane, ethane, hydrogen sulfide, propane and butane among others. The acid gas may be sent to the gas cleaning tank for the removal of hydrogen sulfide in an amine gas treatment unit and through a series of distillation towers for recycling propane, butane and pentane or heavier components. The remaining hydrogen, methane, ethane, and propane may be used as recycled gas. The hydrogen sulfide removed and recovered by the amine gas treatment unit may then be converted to elemental sulfur in a Claus process unit and then passed to a sulfur furnace to produce SO₂. See FIG. 7.

### Hydrodenitrogenation (HDN)

The hydrogenolysis reaction may also be used to reduce the nitrogen content in biooil in a process called hydrodenitrogenation (HDN). The process flow is the same as for an HDS device.

### Catalysts and Mechanisms

The major catalysts are based on molybdenum disulfide (MoS₂) together with minor amounts of other metals. At the edges of MoS₂ crystallites, the molybdenum exchange can stabilize a coordinatively unsaturated site (CUS), also known as an anion vacancy. Substrates, such as thiophene, bind to this site and undergo a series of reactions that result in both CS cleavage and C═C hydrogenation. Thus, hydrogen serves several roles-anion vacancy generation through sulfide removal, hydrogenation and hydrogenolysis.

Ruthenium disulfide may be used as a single catalyst, but binary combinations of cobalt and molybdenum are also active. Apart from the basic cobalt-modified MoS₂ catalyst, nickel and tungsten are also used depending on the nature of the feed. For example, Ni—W catalysts are more efficient for hydrodenitrogenation.

A typical support for catalyst is γ-alumina.

Oil purification from sulfur and ammonia is commonly performed as the last step in oil purification/recovery. The pure gas phase may directly be transported to an ESH tank 9 or a power tank 10. The acid gas may be transported to water scrubbers, where the gas is purified and the chemicals (sulfur, ammonia, etc.) are washed out before further transportation to the tanks 9, 10 and the water cleaning. The acidic water goes to the water cleaning.

### Gas Purification Step:

A prewash step I) may be performed for all gases generated at the various processes.

All gases from the different process steps may be collected in a gas separator 6. The gases may comprise hydrogen, hydrocarbons such as methane, methanol, ethanol, ammonia, SO2, SH, S, etc. and other volatile organic and inorganic compounds such as CO₂.

Cleaning gases may be done using a cryo-technique, whereby gases are condensation and then distilled. The technique allows optimizing of use of energy needed for gas cleaning. The cryo-technique may be used to separate oxygen, nitrogen, hydrogen, carbon oxide, biogas and/or argon from a gas mixture.

Membranes or fiber membranes may be used to clean gases, optionally in combination with cryo-technique. for recycling of oxygen, nitrogen, and hydrogen. An advantage of membrane technique are low investment costs and low maintenance costs.

By collecting all gases odor, emissions, environmental problems in and around the factory are reduced. This reduces the carbon footprint. This allows recycling of the various chemicals contained in the accumulated gases. By purifying the different gases and other chemicals, the quality of the gas and liquids can be improved, which improves the efficiency of the processes in which the chemicals are used and improves the efficiency of the overall process.

By washing the gases in water scrubbers, process chemicals will end up in the water phase, which is then led to the water cleaning steps where a chemical recovery takes place.

Micro Porous Polymer Extraction (MPPE) is an effective technique for removal of carbohydrates from water using liquid/liquid extraction. The technique can be automated, does not produce gases or slam not chemicals. Porous Polymer particles are packed in a column and filled with an extraction liquid, which extract carbohydrates from the liquid that passes through the column. The cleaned water can be reused in the process. The particles can be regenerated using steam to remove the carbohydrates from the particles. MPPE is most effective with a carbohydrate reduction of 90 to 99%. The extraction does not depend on pH, salts or other compounds in the liquid. MPPE is a flexible alternative, because the extraction can be done with water, organic solvents and at different temperatures and pressures. The extraction can thus be varied depending on the type of compounds to be extracted from a liquid.

Storage and transport of cleaned gases can be done in tanks having a capacity between 5 to 1400 m³.

### Water Scrubber for Chemical Recycling.

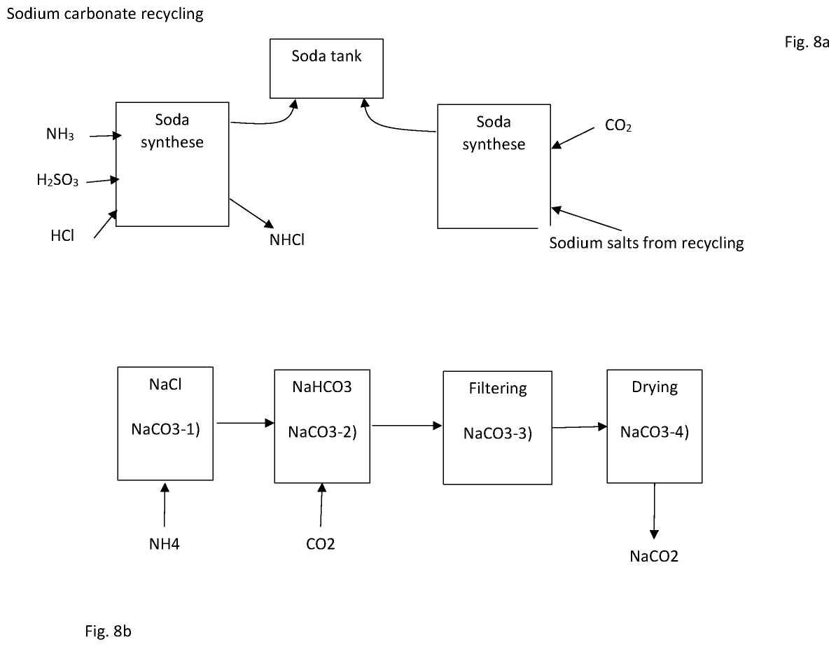

During the various processes, reactors and tanks in the system, different sulfur and ammonia containing gases are produced. These gases may need to be purified from both sulfur and ammonia before combustion, when heat recovery is done as well as subsequent chemical recovery. Through absorption with so-called pressurized water absorption, the gas may be purified from carbon dioxide, hydrogen sulfide and ammonia, as these substances dissolve in water under pressure. Methane also dissolves in water, but its solubility is lower than for the other substances. The solubility of carbon dioxide in water increases with increasing pressure and decreasing temperature. Absorption in water can be designed, whereby the washing water goes to the water purification and chemical recycling. An absorption column may be used to purify process water. The extracted carbon dioxide may be used to upgrade the carbon dioxide as shown in FIG. 8. The upgraded gas goes to the gas boiler 7a for heat recovery and gas cleaning, where additional chemical recovery takes place. Absorption with water is a common technology for separating carbon dioxide from biogas. Separation can be regulated by pressure and the ratio between gas and liquid flow.

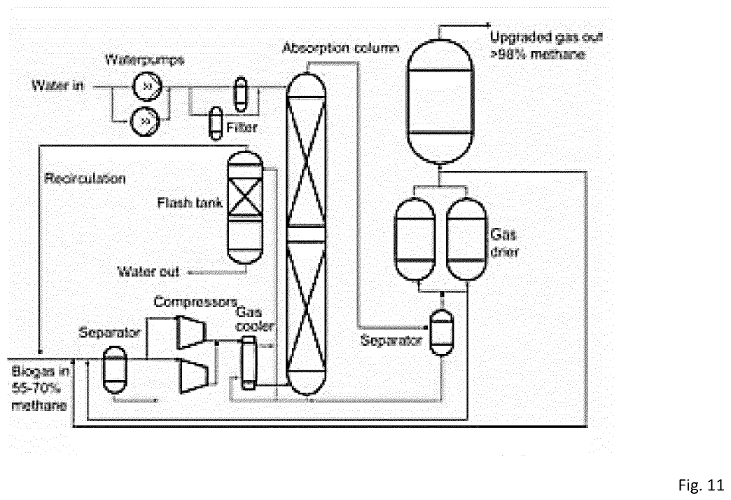

First, liquid phase (water) is separated from the gas. The raw gas is then compressed and introduced into the bottom of an absorption column where the gas upstream meets water which is introduced from the top. A pressure may be 0.6 to 1 MPa. The absorption column may be equipped with filler bodies to provide maximum material transfer. In the column, the carbon dioxide is absorbed by the water and the biogas that leaves the tank is enriched in methane. The upgraded gas may be saturated with water and therefore may need to be dried, for example in an adsorption dryer before it goes to combustion, but this is not a requirement. When methane is partially soluble in water, the water may be transferred from the absorption column to a flash tank, to reduce methane losses. The pressure is reduced in the flash tank, e.g. to 0.25 to 0.35 MPa, whereby some of the dissolved gas is released. Since methane is more easily desorbed from water than carbon dioxide, the gas from the flash tank is rich in methane and may be returned to the raw gas before the compressor to the absorption column. The water may after the flash tank go to a desorption column where the dissolved carbon dioxide is driven off by a countercurrent air flow. The desorption column may be designed just like the absorption column with filler bodies to create a large material transfer. The liquid leaving the desorption column is cooled before being returned to the absorption column. See FIG. 11.

The residual gas from the desorption column contains at least air, the separated carbon dioxide, and methane, which has been removed from the water. Therefore, desorption with air is not recommended when the biogas contains high levels of hydrogen sulfide. In a second type of absorption with water, water is not regenerated in a desorption column but is led away from the plant after the flash tank. This may be more cost effective than regenerating the water if cheap water such as purified wastewater can be used. As the water is not regenerated, no problems arise with precipitation of elemental sulfur. The methane that has dissolved in the water and is not separated in the flash tank accompanies the wastewater from processes to the water purification process.

Clogging or growth of the filler bodies in the absorption column is a common problem in plants with easy passage of water. Purified wastewater may be used, in which there may be some biological material that may get stuck in the filling bodies or causes growth. The growth is due to bacteria and other biological material entering the process to drive the carbon dioxide from the water.

For easily flowing water scrubbers, the column can be washed during operation, when the water is changed, which is an advantage for this technology compared to recirculating water scrubbers. For single-flow water scrubbers, at a dimensioned for 300 nm³ of raw gas per hour the loss of methane is expected to be less than 2%.

Unlike the other upgrade techniques, all methane loss with flowing water scrubbers ends up in the outgoing water. METS sensors may be used for measuring the content of methane in water. With the sensor, the methane content can be measured continuously in outgoing water after the flash tank.

Calculations based on Henry's law predict that the methane loss from the processes of the invention is 2 to 3 v/v % or 3 v/v % at 5 or 10° C. in the water. These calculations show that the methane losses may be below 2 v/v % when recirculating the gas released in the flash tank, while the power consumption is not significantly affected.

An advantage of the process of the invention is that there are substantially none or no fibers and wood substances present in the waste liquids. Most of the impurities, such as organic and inorganic acids can be handled by e.g. chemical precipitation. This makes water purification cheaper in construction and operation.

However, one could, if needed, use a type of Dissolved Air Flotation (DAF) or Dissolved gas flotation (DGF) between the oil water separator and the chemical recovery. The sludge from these flotations goes back to the HTL process together with untreated wastewater.

### Desalination of Water

After the chemical recycling, other water purification processes may become relevant.

There are several processes that can extract salts from water in large-scale industrial production, processes Multi-step Flash distillation (MSF), Multiple Power Distillation (MED) and Chevron's WWT solution are the most proven and reliable processes.

Desalination is an artificial process by which salt water (usually seawater) is converted into fresh water. The most common desalination processes are distillation and reverse osmosis.

There are several processes for desalinating seawater. In the process of the invention, recycling of sodium chemicals may be done by desalination liquids in a water purification step(s) J). Seawater can also be entered in the process for desalination which can then be used in the process. The salt can be used as process chemicals.

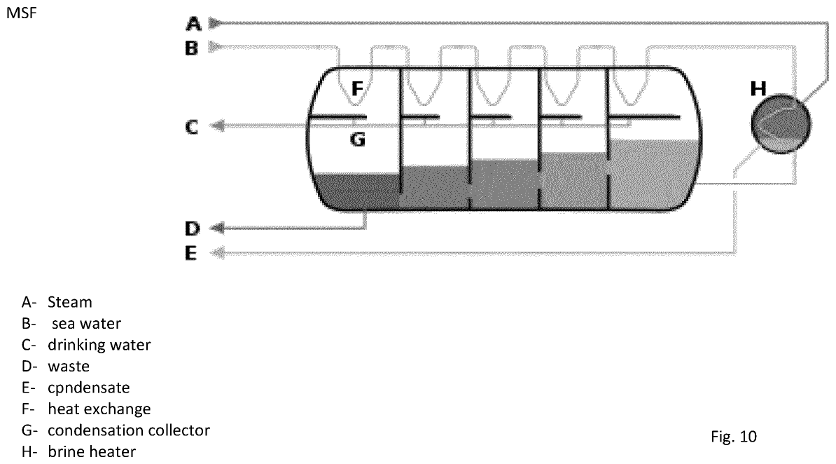

Multi-step Flash distillation (MSF) shown in FIG. 10 is a water desalination process that distills seawater, by evaporating part of the water to steam in several stages of what are mainly countercurrent heat exchangers. The total evaporation in all steps is up to about 85% of the water flowing through the MSF system, depending on the temperature range used. With rising temperature, the difficulties of scaling and corrosion increases. A temperature of 110 to 120° C. may be applied, although scale deviation may require temperatures below 70° C.

In the last step of the MSF distillation, brine and condensate may have a temperature close to the inlet temperature. Saline and condensate are pumped out to ambient pressure. Saline and condensate still carry a small amount of heat that is lost from the system when released. The heat added to the heater compensates for this loss.

The heat added to the brine heater usually comes in the form of hot steam from a process that is preferably co-located with the desalination process. Such MSF distillation can operate with 23-27 kWh/m³ (approximately 90 MJ/m³) distilled water.

In addition, MSF distillations, especially large ones, are often connected to industries where waste heat is used to heat the seawater, which provides cooling to the power tank at the same time. This reduces the energy requirement by half to two thirds, which drastically changes the systems economy, as energy is by far the largest operating cost.

Another technique is Multiple Power Distillation (MED), using thermal or mechanical vapour compression. MED is a distillation process that is often used for desalination of seawater. It consists of several steps. There are different configurations, such as feed, reverse feed, etc. In addition, this steam between different stages uses some heat to preheat incoming salt water. The first and last step require external heating and cooling, respectively. The amount of heat removed from the last stage must be almost equal to the amount of heat supplied to the first stage. For desalination of seawater, even the first and warmest stage is usually operated at a temperature below 70 to 75° C., to avoid scaling.

External feed water must be supplied to the first stage. The pipes in the first stage are heated by means of an external steam source or from another heat source.

Condensate (fresh water) from all pipes at all stages must be pumped out by reducing pressures to ambient pressure of about 0.1 MPa. The saline solution that is collected at the bottom of the last stage must be pumped out because it has a significantly lower pressure than ambient pressure.

Some of the advantages of the water cleaning processes are a low energy consumption compared to other thermal processes. The processes may be performed at a temperature below 70° C. and at low concentration (<1.5 w/w %) to avoid corrosion and scaling. The processes may be performed without pre-treatment of water and can withstand variations in water conditions. The processes are reliable and easy to use, even at large scale. The processes have low maintenance cost. The processes may be performed continuously with minimal monitoring needs. The processes may be adapted to all heat sources, including hot water, waste heat from electricity production, industrial processes, or solar heating. The processes can produce distillates with high purity.

Another alternative is Chevron's WWT solution, where water can be purified from sulfur and ammonia in a so-called Sour Water Stripping process. This is because ammonium bisulfite, ammonium sulfite in the HTL process is converted to H₂SO₃ and SO₂ and NH₃. Once the chemicals have been extracted from the water, they go to a secondary recycling step where they become new process chemicals.

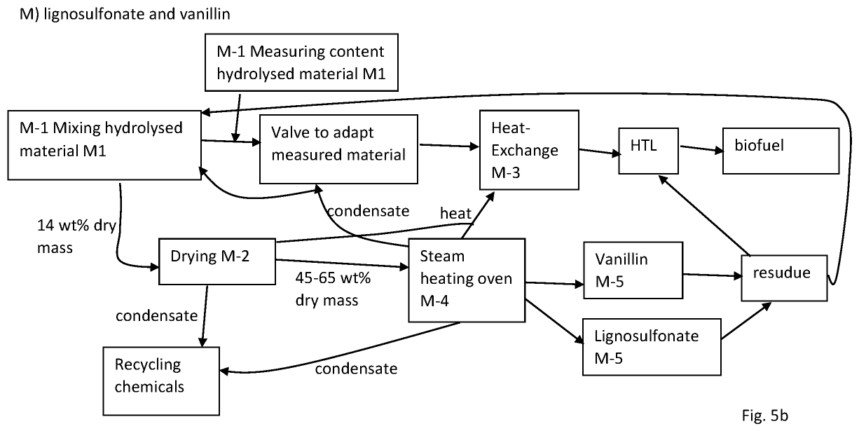

FIGS. 6 to 8 show recycling processes for ammonium, sulfite and sodium carbonate.

Ammonium sulfite/ammonium bisulfite are converted to NH3, H2S, SO2 in a first step in the HTL process under a pressure from 20 to 28 MPa and temperature from 250 to 450 C. The concentration of Na2CO3 is constant.

In the second step, after HTL, the products are separated into three phases, a gas, water and oil phase. NH3, H2S, H2SO3 end up mainly in the oil and water phase while NH3 and SO2 end up in the gas phase.

The chemicals in the gas and oil phases are then extracted into the water phase.

For washing out a gas phase, a water scrubber can be used. For washing out an oil phase, the HDS process can be used. These processes cause the chemicals to end up in the aqueous phase.

The chemicals NH3, H2S, H2SO3, are recycled from the aqueous phase in the water purification process in a third step.

In a pretreatment step NH3, H2S, H2SO3 are removed from acidic water. Operating conditions for water separators may range from 0.01 to 0.35 MPa at a temperature from 38 to 132° C. The acidic water may be acidified with mineral acid before evaporation, if needed.

H2S is easier to remove than NH3. In pure water at 37.8° C., for example, the Henry's Law coefficient for NH3 is 38,000 ppm/psia, while that for H2S is 184 ppm/psia. To remove 90% of NH3, a temperature of 110° C. (230° F.) or higher is usually used, but 90% or more of H2S can be removed at 37.8° C.

A two-stage scrubber for the recycling of sulfide and ammonia may be used.

Acidification with a mineral acid can be used to fix NH3 in a first step and enable more efficient removal of H2S. In the second step, the pH is adjusted by adding caustic to effectively remove NH3.

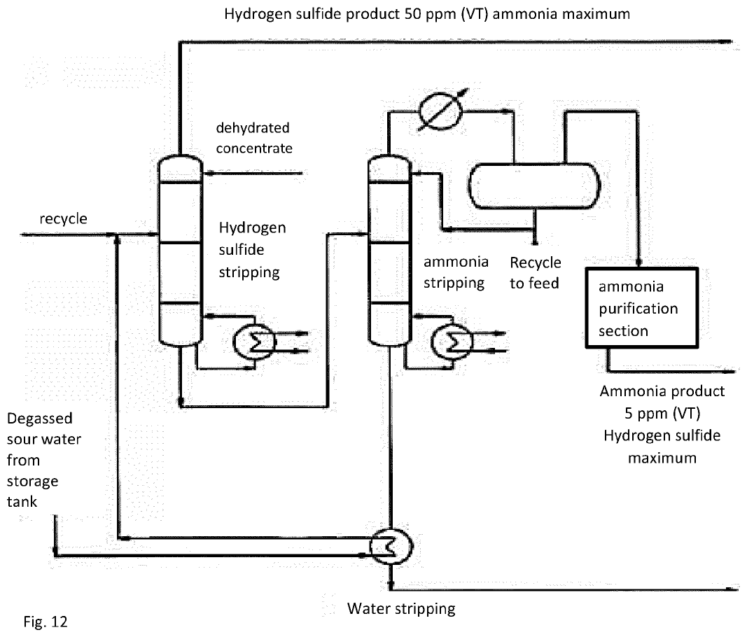

The Chevron WWT process, which is mainly two-stage stripping with ammonia purification, to separate H2S and NH3. H2S goes to a conventional Claus sulfur plant and then to a sulfur furnace to become SO2. (FIGS. 6 and 12) Sulfur that is lost during the process may be added as elemental sulfur at the sulfur furnace according to FIG. 7.

Recovered NH3 is stored in an ammonia tank, where lost NH3 is added e.g. by producing it from air and water as shown in FIG. 6.

In a Chevron WWT process, acid is used in the first step to enhance the removal of H2S, H2SO3. Caustic may be used in the second step to improve the removal of ammonia (FIG. 12).

Due to the stricter sewage requirements for NH3, an increase in acid water removal is important.

Also, for soda, existing recycling techniques can be used. A difference with soda is that it is not converted in HTL. Soda is expected to end up in the water phase and to some extent in the oil phase. In the oil phase, soda is purified together with other salts before the HDS process and is extracted in an aqueous phase which can be purified in a water purification process.

Before soda and other sodium salts are recycled from the aqueous phase with e.g. an MED process, the water first passes through the sulfur and ammonia scrubbers (Chevron WWT) This may minimize the amounts of various sulfides and sulfates in a soda recycling. See FIG. 8.

The process of the invention is modular and flexible and can be used for both high-yield pulp and low-yield pulp (dissolving) and create a higher yield.

The process of the invention does not use an incinerator to recycle the chemicals. The process of the invention allows about all chemicals to be recycled without having to incinerate and use recycling processes and thus creates added value to the process. The chemicals can be produced in a sustainable and green way.

In some aspects, as shown in FIG. 8a, sodium carbonate may be produced using a process comprising or consisting of steps;
NaCO3-1) pressing ammonia through a column comprising concentrated sodium chloride solution to absorb the ammonia,
NaCO3-2) pressing carbon dioxide through the column to produce sodium bicarbonate (NaHCO₃),
NaCO3-3) filtering to separate sodium bicarbonate from the ammonium chloride solution in the column, and
NaCO3-4) heating sodium bicarbonate to a temperature of 140 to 280° C., or 150 to 250° C., or 160 to 230° C., and separating sodium carbonate (NaCO3) and hydrogen,
whereby the pH of the solution in the column is above 7, or from 9 to 14.

In some aspects, the sodium carbonate obtained in step NaCO3-4) is dried. Sodium bicarbonate can easily be separated as it precipitates from the liquid. Preferably, CO2 generated in processes of the invention is used in this process. This reduces costs and improves the carbon food print of the overall process. The hydrogen can be reused in the process of the invention or recirculated using a Haber-Bosch process for the production of ammonia.

In some aspects, ammonia chloride solution is dried. This product may be used as a fertilizer.

The process of the invention reduces use of external water. The process of the invention can be performed entirely or almost entirely using the bound water that comes in via the biomass used in the processes.

The process of the invention is energy-optimized since less energy is consumed compared to known sulfite and sulphate processes.

About 60 to 80%, or 70% of nitrogen is used in the different processes of the invention, such as fermentation and as hydrogen donor. About 0.1 to 5%, or 1% of nitrogen is used during cleaning. About 20 to 40%, or 30% of all nitrogen can be recycled through different cleaning processes. This reduces cost and improves the environmental friendliness of the process.

FIG. 4a shows a process according to some aspect of the invention, which includes integrated gas and water cleaning during an oil cleaning process. In some aspects, the process for oil cleaning comprises or consists of steps;
C) separating liquids, including oil, and gases from prior process steps for cleaning and reuse of liquid, gases and chemicals contained therein in tank 7,
H-oil 1) transporting gases to either a gas cleaning tank 7, 17, 20 for recycling of gases, transporting oil to a gas oven 7a and water to cleaning tank 21 for recycling of chemicals and water,
H-oil 2) cleaning the oil in a cyclone cleaner (H-oil 1) to separate coal from oil,
H-oil 3) cleaning oil from ammonium/ammonia in a scrubber (H-oil 2) and or cleaning oil from sulfur containing compounds in a scrubber (H-oil 3), whereby ammonium/ammonia and sulfur containing compounds are cleaned and reused in the process,
H-oil 4) distilling the oil one or more times to obtain different fractions of oils in tank (H-oil 4), such as raw light biooil that can be used as fuel and raw heavy oil that can be used in asphalt,
and whereby any gases produced during the oil cleaning process are transported to gas cleaning tanks 17, 20 for further processing.

In some aspects, a heat exchanger (H-oil 5) is used prior to returning the recycled compounds to the recycling plant 20, 21.

### Ammonium Bisulfite

NH4HSO3 may be produced by mixing NH₄OH with SO2, or by spraying NH4OH into a flow of SO2. NH4HSO3 is obtained as a yellowish liquid. In case of overproduction, NH4HSO3 can be used to make ammonium sulphate ((NH₄)₂SO₄) by addition of ammonia (NH₃) and oxygen gas.

### Urea

Urea can be produced by reacting ammonia with CO2 at about 200° C., followed by evaporation, optionally cleaning to obtain a solid product. CO2 and NH3 produced in other processes can be used in this process. Urea can be used to produce cellulose carbamate which is a derivate of cellulose dissolving mass. Urea can also be used in fermentation processes, as fertilizer and a in synthesis of other chemical compounds.

About 580 kg NH3 and 760 kg CO2 can be used to produce 1000 kg urea. The process uses about 85 to 165 kWh of energy and about 900 to 2300 kg steam.

### Hydrogen Peroxide

H2O2 may be produced using an anthraquinone process which is based on the reduction of oxygen, the direct synthesis from the elements. Instead of hydrogen itself, a 2-alkyl-anthrahydroquinone, which is generated before from the corresponding 2-alkyl-anthraquinone by catalytic hydrogenation with palladium is used. Oxygen and the organic phase react under formation of the anthraquinone and hydrogen peroxide. The obtained H2O2 may be distilled to improve the purity of the product.

H2O2 may come from biogas production or electrolysis, t.ex. from production of NaOH and chloride.

Peracetic acid (CH3CO2OH)

Peracetic acid may be produced by mixing acetic acid with H2O2. Sulfuric acid may be used to accelerate the reaction. Alternatively, Peracetic acid may be produced by oxidation of acetic acid.

### Acetic Acid (CH₃COOH) and Acetic Acid Anhydride (CH3CO)2O

Acetic acid anhydride may be produced by oxidation of ethanol (e.g. from fermentation process K) with air. A silver catalyst may be used. Distillation may be used to improve the yield of the process. Acetic acid anhydride may be produced from glacial acetic acid via ketene (CAS no 463-51-4).

Acetic acid may be produced by catalytic oxidation of acetic acid anhydride. Distillation may be used to improve the yield of the process.

Acetic acid is used to produce acetic acid anhydride (CH3CO)2O, which is used to produce cellulose acetate. Cellulose acetate is used to produce textiles, film material etc. Acetic acid may also be used for production of other chemicals.

### Reprocessing

### Ethanol and Food Products

In some aspects, the process as defined in any aspect above, further comprises or consists of the steps of
K) or K-1) and K-2) a first fermenting of the hydrolyzed material by the addition of yeast into ethanol in a first fermentation tank 14.

In some aspects, the yeast is selected from the group comprising or consisting of Saccaromyces cerevisea, Saccaromycesuvarum, Schizosaccharomyces pombe and Kluyveromyces. The yeast preferably tolerates high concentration of ethanol. In some aspects, the amount of yeast is 5 to 15 g/l, or about 12 g/l. In some aspects, the yeast is Saccaromyces cerevisea. In some aspects, the yeast used for fermenting is Zymomonas mobilis or synthetic variations thereof. At least part of the gases, such a carbon dioxide and water from a first fermentation tank 14 can be converted into synthetic hydrocarbon gas and water, using an electrolysis synthetic hydrocarbon production tank (ESH) 9. See FIG. 2.

### Food Products

In some aspects, the process further comprises or consists of the steps of
L) a second fermenting of the hydrolyzed material and/or material from the first fermentation by the addition of yeast and sugar into mammal food products in a second fermentation tank 15. In one aspect, the yeast used for fermenting is Saccharomyces cerevisiae or synthetic variations thereof adapted to produce proteins and ethanol.

At least part of the gases, such a carbon dioxide and water from the second fermentation tank 15 can be converted into synthetic hydrocarbon gas and water, using an electrolysis synthetic hydrocarbon production tank (ESH) 9. This process can be used to produce a protein comprising product suitable for animal food.

### Lignosulfonate or Vanillin

In some aspects, the process further comprises or consists of the steps of
M) converting the hydrolyzed material and/or material from the first and/or second fermentation into lignosulfonate and/or vanillin. At least part of the gases, such a carbon dioxide and water from a lignin tank 16 can be converted into synthetic hydrocarbon gas and water, using an electrolysis synthetic hydrocarbon production tank (ESH) 9.

In some aspects, the process as defined in any aspect above, further comprises or consists of the steps of
K) fermenting hydrolyzed material by the addition of yeast into ethanol in a first fermentation tank 14,
L) fermenting hydrolyzed material from the first fermentation tank 5 with the addition of yeast and sugar into mammal food products in a second fermentation tank 15, and
M) converting the material from the fermentation tank 15 into lignosulfonate and/or vanillin in a lignin tank 16. See FIG. 3.

At least part of the gases, such a methane, oxygen, hydrogen sulfite, nitrogen, carbon dioxide and water from the different tanks 14, 15, 16 can be converted into synthetic hydrocarbon gas and water, using an electrolysis synthetic hydrocarbon production tank (ESH) 9.

The rest products from the first fermentation can be used in the second fermentation and the rest products from the second fermentation can be used in the lignin sulfonation. The rest product from the lignin sulfonation can be used in the HTL or HTC. This reduces waste material produced by the process and improves the overall efficiency of the process.

The choice of hydrolysis process A1) to A5) can be adapted to the organic material to be fermented. The hydrolysis may be an alkaline hydrolysis followed by a neutralization step to breakdown lignin to increase the production of sugars from the organic material.

In some aspects, the process as defined in any aspect above, further comprises or consists of the steps of
M-1) measuring a content of hydrolysed material from step A3) and mixing liquid and solid material to obtain material having a 5 to 45 wt %,
M-2) drying a first portion of the starting material until a dry mass of 45 to 65 wt %, or 50 to 60 wt %, or 55 to 58 wt % is obtained,
M-3) drying a second portion of the starting material in a heat exchanger prior to carbonization in a HTL,
whereby the condensates from steps M-2) and M-3) are removed to recycle chemicals contained therein or are added to step M-1),
M-4) steam heating the dried mass from step M-2) at 350 to 500° C., or 400 to 450° C., whereby the condensate is removed to recycle chemicals contained therein or is added to step M-1), and whereby the heat is re-used in the processes, such as in the heat exchanger,
M-5) producing vanillin and lignosulfonate from the dried material obtained in step M-4), whereby any residues from step M-5) are reused in steps M-1), M-2) or M-3), and whereby the condensates are removed to recycle chemicals contained therein.

In some aspects, heat from the HTL is used in one or more steps M-1) to M-5).

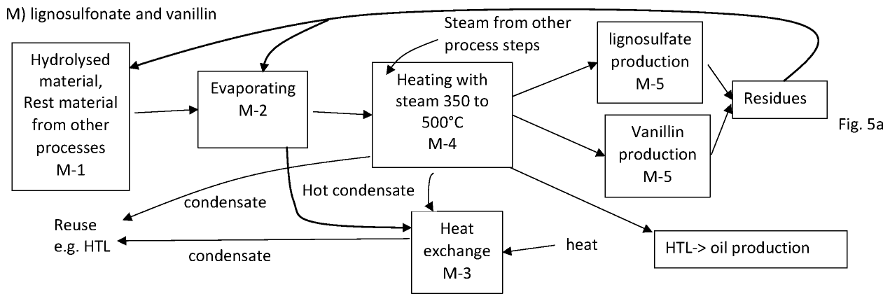

This process M as shown in FIG. 5b, allows reuse of energy by reusing heat and materials. This reduces the overall use of energy and thus costs for process M and for the process of the invention. Also, chemicals can be recycled and reused, which again reduce costs for chemicals used in the process. This improves the effectiveness of the processes.

The use of NH4HSO2 during hydrolysis improves sulfonation of the lignin, which increases yield of the process. The hydrophilic lignosulfonate can easily be separated from the other materials. Further, NH4HSO2 left in the condensates is relatively easy to recycle and thus reuse, which improves the overall yield of the processes. By using NH4HSO2, about 50 wt % of lignin can be used for vanillin and lignosulfonate production, while about 50 wt % of lignin can be used in HTL for the production of biofuel and the like.

Measuring and mixing in step M-1) is used for optimizing the content of the material that is further processes in the other steps of the process. This step ensures that the content of lignin in the material used in the HTL does not have too much lignin, which may result in an increased amount of coal and thus impair the quality of biofuel produced from such coal, or too low lignin content, which increases the risk for byproduct formation in the HTL and thus decrease the energy-content of biofuel. A low lignin content in the HTL would also reduce the amount of chemicals that can be recycled.

Prior to heat steaming in step M-3), the material must be dried in step M-2) to ensure a viscosity, which allows the material to be transported to the HTL or the oven (M5).

Lignosulfonate can be used in the food industry, or as fertilizer (optionally by adding nitrogen from the recycling plant). The products obtained are fossil-free products.

Lignosulfonate can also be used as (dust) binder in for example concrete or asphalt. The process M allows production of lignosulfonate in an economically sound manner, which can be used in concrete and asphalt. This use could reduce the use of fossil products in asphalt. This may improve the carbon-foot print of concrete and asphalt.

### Cellulosic Products

In some aspects, the process as defined in any aspect above, further comprises or consists of the steps of
N1) filtering the hydrolyzed material
N2) washing the filtered material
N3) cleaning the washed material by
   N3-a) bleaching the washed material, and/or
   N3-b) dewatering the washed material, and
N4) processing the material for use in cellulose products, such as paper, tissues or viscose material.

In some aspects, the process as defined in any aspect above, comprises or consists of the steps of
optionally E1) treating wood chips with hot air at a temperature between 4° and 80° C. to accelerate resin maturation,
F-1) steaming the wood chips at a temperature of 80 to 150° C. at a pressure of 0.1 to 0.5 MPa during 1 to 30 minutes, or 1 to 15 minutes,
optionally defibrating the material,
then hydrolyzing the obtained material in step A3) using ammonium bisulfite at a temperature of 140 to 170° C., a pH of 4.5 to 6 for 1 to 3 hours and a liquid/material ratio of 2.5 to 4.5, at a pressure from 0.1 to 3, or 0.1 to 1 MPa until a kappa numbers of above 32.5,
A3-S) hydrolyzing the obtained material in step A3) using sodium carbonate (30 to 35 wt %) at a temperature of 150 to 175° C., a pressure of 0.1 to 1 MPa for 0.5 to 4 hours, followed by
optionally E2) filtering and fractioning the hydrolyzed material to remove a remaining resin,
N1) filtering the hydrolyzed material,
N2) washing the filtered material,
N3) cleaning the washed material by
   N3-a) bleaching the washed material, and/or
   N3-b) dewatering the washed material, and
N4) processing the material for use in cellulose products, such as paper, tissues or viscose material,
   B) hydrothermal carbonizing a portion of the hydrolyzed material that is not further processed using hydrothermal liquefaction (HTL) or hydrothermal carbonization (HTC) to produce at least biooil,
   C) separating liquids and gases from prior process steps for cleaning and reuse of liquid, gases and chemicals contained therein,
   D) generating electricity and/or steam to perform the steps of the process by using liquid, gas, biooil or bio-coal produced in the prior process steps, to operate at least a part of the steps of the process.

In some aspects, bleaching is done using hydroxy peroxide, optionally combined with an acid.

In some aspects, bleaching the washed material is done using oxygen and hydroxy peroxide. Optionally, peroxyacetic acid is used prior to using hydroxy peroxide.

In some aspects, bleaching may comprise or consist of the steps of
N3-a-1) treating the washed material with oxygen, and
N3-a-2) treating the oxygen treated material with hydroxy peroxide,
Optionally pretreating the oxygen treated material with peroxyacetic acid to increase the yield of step N3-a-2).

For production of cardboard and liners, some of the fibers (15 to 25 wt %) may be returned during the production to improve the strength of the end product. For example, instead of transporting rest fibers to hydrothermal carbonizing step B), the fibers may be returned in step N4).

Oxygen lowers the kappa number in the mass. Oxygen also improves the brightness of the end product. Advantageously, oxygen produced in other processes can be isolated and reused in step N3).

If the cellulose product is to be used for production of food, such as animal food, one or more dewatering step N3-b) can follow a washing step. In some aspects, dewatering is done using a screw dryer to reduce the water content to 40 to 60% or about 50%. In some aspects, dewatering is done using a screw dryer to reduce the water content to 40 to 60% or about 50% followed by an additional dewatering step to reduce the water content to 15 to 35%, or about 20% to 30%.

At least part of the gases, such a carbon dioxide and water can be converted into synthetic hydrocarbon gas and water, using an electrolysis synthetic hydrocarbon production tank (ESH) 9.

This process can be used to produce cardboard, corrugated board, liner, fluting, paper, viscos, tissue, among others.

This process N) can be used to produce (Kraft) liners from softwood like conifer. The yield of unbleached kraft-liner is about 75% and the yield for bleached kraft-liner is about 60 to 70%.

This process N) can be used to produce liners from deciduous tree like eucalyptus or birch. The yield of unbleached kraft-liner is about 60 to 70%.

This process N) can be used to produce unbleached fluting from deciduous tree like eucalyptus or birch. The yield of unbleached kraft-liner is about 80 to 85%.

This process N) can be used to produce tissues from either deciduous tree or conifers. The yield after bleaching is about 60%.

### Definitions

As used herein “atmospheric pressure” means a pressure of about 0.101325 MPa.

As used herein “fossil free” means not derived from carbon reserves stored in the earth. Synonyms for fossil-free hydrocarbons may be biogenic hydrocarbons or hydrocarbons derived from lignocellulosic material or biomass.

As used herein “liquid” means to include oil, where appropriate.

As used herein “carbonization” means carbonization or liquefication. For example when an HTL is used the word “carbonization” means carbonization.

As used herein “lignocellulosic” means any material from organic origin, such as, but not limited to, hard wood, soft wood, herbaceous energy crops, short-rotation energy crops, agricultural products or any waste thereof, sewer waste or other biodegradable waste waters, or manures, or effluent from cellulose, paper or wood processing plants. Examples of lignocellulosic may be materials from leaf trees, such as birch trees, or coniferous trees such pine or fir trees.

Lignocellulosic material” includes “biowaste” defined as all material of biological origin, excluding only material imbedded in geological formations and fossilized.

As used herein “biooil” means fuels produced from biomass that can be used as alternatives to gasoline and diesel. Biofuels may be in liquid or gaseous form.

As used herein “herbaceous energy crops” means plants with no or little woody tissue and grown for production of food or feed. Examples may be grasses, sugarcanes, corn, soybeans, wheat, barley, sunflower, rapeseed, and the like.

As used herein “short-rotation energy crops” means fast growing softwoods, such as pine, spruce, birch and cedar or hardwoods, such as poplar, willow, and eucalyptus.

As used herein “sulfide comprising compounds” also includes sulfur comprising compounds.

As used herein “thermohydrolyis” means hydrolysis at a temperature between 2° and 220° C. and a pressure between 0.1 and 30 MPa, without addition of alkalic or acidic additives.

As used herein “HTC” means a process, wherein organic material is heated to a temperature between 15° and 250° C. and a pressure between 2 and 5 MPa, typically a temperature between 18° and 200° C. and a pressure between 2.5 and 3.5 MPa.

As used herein “HTL” means a process, wherein organic material is heated to a temperature between 25° and 550° C. and a pressure between 20 and 30 MPa, typically a temperature between 35° and 400° C. and a pressure between 22 and 27 MPa.

As used herein “sludge” means a primary sludge from first sedimentation, or bio-sludge, which is primary sludge modified by bacteria and air, and/or chemical sludge, which is chemically modified primary or bio-sludge.

As used herein “fermentation” means a chemical breakdown of a substance by bacteria, yeasts, or other microorganisms.

As used herein “%” means weight percentage wt % or w/w %, i.e. a percentage of the sum of the weight of all ingredients, unless otherwise stated.

As used herein “v/v %” means volume percentage, i.e. a percentage of the sum of the volume of all ingredients, unless otherwise stated.

It is to be understood that for the sake of clarity not all possible connection lines between the different tanks used in the process are drawn in the figures. It is to be understood that more connections are possible than visualized in the figures. For example, the lines between the fermentation tank 15 and the mixing tank are not illustrated in the figures but can be present.

It is to be understood that gases, liquids, and chemicals contained therein from any of the processes included in the process of the invention can be cleaned, purified and reused.

### Example of Pre-Hydrolysis Followed by Alkaline Hydrolysis

### Pre-Hydrolysis

| Birch chips | 2000 g |
|---|---|
| Ammonium sulphide 0.25% w/w | 5 g |
| Water at weight ratio 6:1 | 12 000 g |
| Temperature increase | 40° C. per minute |
| Pre-hydrolysis temperature | 155° C. |
| Pre-hydrolysis period | 170 minutes |
| Loss of birch chips | 26.6% |

### Alkaline Hydrolysis

| | |
|---|---|
| Na₂SO₃ w/w % of total weight birch chips | 22 |
| Na₂CO₃ w/w % of total weight birch chips | 5 |
| Water at weight ratio | 4.5:1 |
| pH | 11.3 |
| Temperature increase | 1° C. per minute |
| Hydrolysis temperature | 175° C. |
| Hydrolysis period | 170 minutes |
| Yield | 36.7% |
| Alpha cellulose | 94.2% |
| Viscosity | 764 dm³/kg |

The example shows that cellulose can be obtained at high yield dependent on the conditions of the hydrolysis.

Separation of Alcohols after Hydrolysis

Thermohydrolysis of birch chips in water at 168 g/l and 31.9 kg of birch in 190 l water was heated to a temperature of 140 to 150° C. at atmospheric pressure (0.1 MPa) until about 8 w/w % of the birch chips are in solution. The solution was than filtered and the alcohols separated from the solution using a pressure filter (Seitz-Zenith, k150). The filtrate contained 140 g/l of which 21.4 kg dry substance, while the feed contained 224 g/l birch and 8.3 g of dry substance. Thus, 96% of the carbon hydrates is present in the feed, while 76% of the dry substance ended up in the filtrate. The feed contained 0.2% mannose, 0.3% glucose, 0.8% ramose, 2.4% arabinose, 3.0% galactose and 93.3% xylose. All these carbohydrates can be used in a fermentation process.

The residue in the filtrate is processed in an HTC by heating the organic material to a temperature of 200-220° C., under a pressure of 3 MPa for about 12 hours to obtain bio-coal, ashes, ammonium, lignin, and sulphate.

| | Pre | | | |
|---|---|---|---|---|
| Start | hydrolysis | Hydrolysis | HTL | HTL |
| material | conditions | conditions | conditions | product |
| 1000 g | T 100° C. | T 150° C. | T 350° C. | 446 g Bio- |
| DS Spurs | P 0.1 MPa | P 0.1 MPa | P 25 MPa | oil |
| | pH 4-5 | pH 1-3 | pH 5-6 | 93 g Bio-gas |
| | | | | 30 g Ashes |

| | Pre | | | |
|---|---|---|---|---|
| Start | hydrolysis | Hydrolysis | HTL | HTC |
| material | conditions | conditions | conditions | product |
| 1000 g | T 150° C. | Non | T 336° C. | 486 g Bio- |
| DS | P 0.1 MPa | | P 21 MPa | bitumen |
| Biomass | pH 1-3 | | pH 5-6 | 91 g Bio-gas |
| from | | | | 32 g Ashes |
| wood | | | | |

The advantages of the process of the invention using an ammonium base are many. Divalent ions, such as Ca²⁺ and Mg²⁺ give a slightly lower pH effect than monovalent ions, which can be explained by the ionic strength being affected by ion valency by a factor two. This results in a slightly higher hydrolysis rate for monovalent bases because of the higher hydrogen ion content. Since bisulfite hydrolysis, which usually occurs with Mg²⁺, occurs at lower hydrogen ion content than acid sulfide hydrolysis, bisulfite hydrolysis is carried out at a higher temperature of about 150-165° C. compared to a temperature for acid sulfide hydrolysis of 125 to 145° C. The lower temperature for acid sulfite hydrolysis is used for pulp, which is to become paper, while the higher temperature is used for viscous pulp hydrolysis. Hemicellulose is more easily dissolved at a higher temperature, and for viscose pulp a low hemicellulose content is desired, which explains the higher temperature.

| | Pre- | | | | | |
|---|---|---|---|---|---|---|
| Start | hydrolysis | Hydrolysis | Fermenting | Fermenting | Fermenting | Fermenting |
| material | conditions | conditions | V conditions | V product | VI conditions | VI product |
| 1000 g | T 100° C. | T 150° C. | 18 g yeast | 120 g | 0.013 g yeast | 67 g food |
| Wood | P 0.1 MPa | P 0.1 MPa | (Zymomonas | alcohol | (Saccharomyces | product |
| Biomass | pH 4-5 | pH 1-3 | mobilis) | | cerevisiae) | |
| | | | 200 g sugar | | 200 g sugar | |
| 1000 g | Non | Non | 50 g yeast | 440 g | 0.036 g yeast | 185 g food |
| sugarr | | | (Zymomonas | alcohol | (Saccharomyces | product |
| cane | | | mobilis) | | cerevisiae) | |
| melasse | | | 550 g sugar | | 550 g sugar | |

T = temperature, P = pressure, DS = dry substance in weight %,

The pH is normally increased by adding NaOH. In the process of the invention ammonia is used to increase the pH value. Because ammonia can be manufactured and recycled in the process, the use of ammonia reduces process costs. Some bleeding can occur by ammonia converting to nitrogen, which is also a prerequisite in the HTL process to have an oxygen-free pyrolysis process. However, it has been indicated that acid-saturated water can increase the oil quality. However, by adding oxygen in the HTL process, the quality is reduced, and various oxygen bonds increase. On the other hand, if there is an increased nitrogen In the HTL process, the quality and production of oil increases while reducing oxygen binding.

By increasing the influx of ammonia and ammonium, which to a certain extent convert to nitrogen, the HTL process's efficiency seems to increase significantly, with improved oil quality, while the chemicals can be recycled.

Acid sulfite for dissolving pulp is normally based on fir. The hydrolysis is directed to a larger hemicellulose solution compared to normal the pulp cook. This is achieved by a limited loading of bound SO₂, whereby the final phase of the hydrolysis can be carried out at a lowered pH, which gives the pulp a lower hemicellulose content and thus a higher cellulose content. The hemicellulose content is then further reduced in a subsequent alkali breeding step. With pretreatment at slightly higher pH (4-5 measured cold), pine wood can also be used but then coupled to a special resin.

Acid sulfite hydrolysis can thus be preceded by a treatment at higher pH and slightly lower temperature to make the hydrolysis more selective. The first step is either at pH about 5, which makes it possible to cook to lower kappa numbers but unchanged strength, or at about PH 6.5-8 to increase the pulp yield, but with reduced strength, due to the higher hemicellulose content in the pulp. The increasing yield in this latter case is mainly due to a reduced release of the glucomannan of the wood, which changes the nature of the pulp towards better grindability, but at the price of lower pulp strength. For two-stage hydrolysis of viscose pulp, a lower pH level (4-5) can be used in the first step to reach the desired low 5 hemicellulose content in the pulp.

Reference numbers

| Process step | | Tank/reactor | |
|---|---|---|---|
| A | hydrolyzing | 3, 4, 6 | |
| B | carbonizing | 5 | |
| C | separating | 7, 17 | |
| D | generating | 10 | |
| | electricity and/or | | |
| | steam | | |
| E | cleaning | 1 | |
| F | impregnation | 2 | |
| G | Converting | 9 | |
| H | Cleaning oil | 8, 11, 19 | |
| I | Cleaning gases | | |
| J | Cleaning water | | |
| K | 1st fermentation | 14 | |
| L | 2nd fermentation | 15 | |
| M | Lignosulfonting | 16 | |
| N | Cellulose synthese | 18 | |
| | | 12 | Desalinator tank |
| | | 13 | Rediner tank |

1. A process for production of fossil free or bio-hydrocarbons from lignocellulosic material comprising the steps of:
A) hydrolyzing the lignocellulosic material using ammonium bisulfite, whereby the conditions of the hydrolysis are being controlled by regulating pH, temperature, color, pressure, sulfite content, kappa number and/or R18, such that the hydrolyzed material can be further processed,
B) hydrothermal carbonizing/liquefaction a portion of the hydrolyzed material using hydrothermal liquefaction (HTL) or hydrothermal carbonization (HTC) to produce at least biooil,
C) separating liquids, including oil, and gases from prior process steps for cleaning and reuse of liquid, gases and chemicals contained therein, and
D) generating electricity and/or steam to perform the steps of the process by using liquid, gas, biooil or bio-coal produced in the prior process steps, to operate at least a part of the steps of the process.

2. The process according to claim 1, whereby a cleaning step E) is performed to remove resin present in the lignocellulosic material comprising the steps of:
E1) treating wood chips with hot air at a temperature from 40 to 80° C., prior to hydrolysis, to accelerate resin maturation, and
E2) filtering and fractioning the hydrolyzed material to remove a remaining resin.

3. The process according to claim 1, whereby an impregnation step F) is performed prior to hydrolysis comprising the steps of:
F-1) steaming the wood chips at a temperature of 80 to 150° C. at a pressure of 0.1 to 0.5 MPa during 1 to 30 minutes, or 1 to 15 minutes, and
F-2) pre-hydrolyzing the material obtained in step F1) using ammonium sulfite at a pH of 4 to 7, a temperature of 70 to 170° C., or 80 to 150° C., a pressure of 0.1 to 1.5 MPa for 1 to 300 min, or 5 to 250 min.

4. The process according to claim 1, whereby the hydrolyzing step A) is performed using the step of
A1) hydrolyzing the lignocellulosic material using ammonium bisulfite at a temperature between 80 and 200° C. for a period of 0.5 to 36 hours and at a pressure between 0.1 and 1.5 MPa.

5. The process according to claim 1, whereby the hydrolyzing step A) is performed using the step of
A2) hydrolyzing the lignocellulosic material using ammonium bisulfite at a temperature of 125 to 170° C., a pH of 4 to 7 for 2 to 6 hours and a liquid/material ratio of 2.5 to 4.5.

6. The process according to claim 1, whereby the hydrolyzing step A) is performed using the step of
A3) hydrolyzing the lignocellulosic material using ammonium bisulfite at a temperature of 125 to 170° C., a pH of 4 to 7 for 2 to 6 hours and a liquid/material ratio of 2.5 to 4.5, and
A3-S) hydrolyzing the obtained material in step A3) using sodium carbonate (20 to 35 wt %) at a temperature of 100 to 200° C., a pressure of 0.1 to 1 MPa for 0.5 to 4 hours.

7. The process according to claim 6, wherein the hydrolyzed material from step A3-S) is further processed using a process comprising the step of:
M-1) measuring a content of hydrolysed material from step A3-S) and mixing liquid and solid material to obtain material having a 5 to 45 wt %,
M-2) drying a first portion of the starting material until a dry mass of 45 to 65 wt %, or 50 to 60 wt %, or 55 to 58 wt % is obtained,
M-3) drying a second portion of the starting material in a heat exchanger prior to carbonization in step B),
whereby the condensates from steps M-2) and M-3) are removed to recycle chemicals contained therein or are added to step M-1),
M-4) steam heating the dried mass from step M-2) at 350 to 500° C., or 400 to 450° C., whereby the condensate is removed to recycle chemicals contained therein or is added to step M-1), and whereby the heat is re-used in the processes, such as in the heat exchanger, and
M-5) producing vanillin and lignosulfonate from the dried material obtained in step M-4), whereby any residues from step M-5) are reused in steps M-1), M-2) or M-3), and whereby the condensates are removed to recycle chemicals contained therein.

8. The process according to claim 6, wherein the hydrolyzed material from step A3-S) is further processed using a process comprising the step of:
N1) filtering the hydrolyzed material,
N2) washing the filtered material,
N3) cleaning the washed material by,
N3-a) bleaching the washed material, and/or
N3-b) dewatering the washed material, and
N4) processing the material for use in cellulose products, such as paper, tissues or viscose material.

9. The process according to claim 1, whereby the hydrolyzing step A) is performed using the step of:
A4) hydrolyzing the lignocellulosic material using ammonium bisulfite at a temperature of 70 to 170° C., a pH of 3 to 7 a pressure of 0.1 to 1.2 MPa, for 0.5 to 6 hours and a liquid/material ratio of 2.5 to 5, and
A4-D) defibrating and/or beating the obtained material in step A4), and
optionally A4-Df) removing fine material, and
optionally, A4-R) adding recycled paper material to the defibrated material in step A4-D).

10. The process according to claim 1, whereby the hydrolyzing step A) is performed using the step of:
F-2) prehydrolysing the steamed biomass using NH4HSO3, a pH 3 to 7, a temperature 80 to 250° C., and an atmospheric pressure for 5 to 360 minutes, cleaning the prehydrolysed product,
A5) hydrolysing the prehydrolysed product using SO₂ at 1 to 15 wt % of dry mass, a temperature 125 to 350° C., a pressure of 0.5 to 4 MPa for 1 to 20 minutes, and
A5-S) hydrolysing the obtained the hydrolysed product using SO₂ at 1 to 75 g/l and NH4OH, a pH 2 to 7, a temperature 90 to 250° C., a pressure of 0.1 to 2 MPa for 1 to 75 minutes.

11. The process according to claim 1, wherein step A) includes two or more hydrolysis steps A1 to A5 performed in parallel; wherein:
A1) comprises hydrolyzing the lignocellulosic material using ammonium bisulfite at a temperature between 8° and 200° C. for a period of 0.5 to 36 hours and at a pressure between 0.1 and 1.5 MPa;
A2) comprises hydrolyzing the lignocellulosic material using ammonium bisulfite at a temperature of 125 to 170° C., a pH of 4 to 7 for 2 to 6 hours and a liquid/material ratio of 2.5 to 4.5;
A3) hydrolyzing the lignocellulosic material using ammonium bisulfite at a temperature of 125 to 170° C., a pH of 4 to 7 for 2 to 6 hours and a liquid/material ratio of 2.5 to 4.5;
A4) hydrolyzing the lignocellulosic material using ammonium bisulfite at a temperature of 70 to 170° C., a pH of 3 to 7 a pressure of 0.1 to 1.2 MPa, for 0.5 to 6 hours and a liquid/material ratio of 2.5 to 5, and
A5) hydrolysing the prehydrolysed product using SO₂ at 1 to 15 wt % of dry mass, a temperature 125 to 350° C., a pressure of 0.5 to 4 MPa for 1 to 20 minutes.

12. The process according to claim 4, wherein step B) comprises the steps:
B-1) mixing starting material having a concentration of 45 to 65 wt %, or 50 to 60 wt %, or 54 to 56 wt %, whereby the starting material may be hydrolyzed material from step A1), A2), A3) and/or A4) or any residue material from steps K) to N), with liquid having a temperature of at least 200° C. or 300° C., to obtain a material having a concentration of 25 to 45 wt %, or 30 to 40 wt %, or 34 to 37 wt % and a temperature of at least 250° C.,
B-2) temporizing the heated material obtained in step B-1) further to at least 300° C., or to 300 to 400° C., optionally using induction heating, and
B-3) carbonizing/liquefying the temporized material in one or more hydrothermal liquefaction (HTL) reactor B-5 for 20 to 30 minutes, at a temperature of 300 to 400° C., or 320 to 390° C., or 340 to 380° C., at a pressure of 15 to 25 MPa.

13. The process according to claim 1, whereby hydrolysis is performed continuously.

14. The process according to claim 1, whereby separated gases from step C) are cleaned using water scrubbing to remove at least carbon dioxide, sulfate, hydrogen sulfide, ammonia and methane, whereby water used during scrubbing is transported for further cleaning.

15. The process according to claim 1, whereby separated liquids from step C) are cleaned using multi-step Flash distillation (MSF), multiple-effect destillation (MED) or sour water stripping (Chevron WWT).

16. The process according to claim 1, wherein a process for oil cleaning in step C) comprises steps:
H-oil 1) transporting gases, liquid, oil for recycling for cleaning and recycling of gases, liquid, oil and chemicals contained therein,
H-oil 2) cleaning the oil to separate coal from oil,
H-oil 3) cleaning oil from ammonium/ammonia by scrubbing and or cleaning oil from sulfur containing compounds by scrubbing, whereby ammonium/ammonia and sulfur containing compounds are cleaned and reused in the process,
H-oil 4) distilling the oil one or more times to obtain different fractions of, such as raw light biooil that can be used as fuel and raw heavy oil that can be used in asphalt,
and whereby any gases produced during the oil cleaning process are transported and cleaned for further processing.

17. The process according to claim 1, wherein raw biooil is desalted/cleaned in step C) by a process comprising the steps:
H1) mixing oil with 2 to 4 w/w % water and heating the mixture at a temperature of 90 to 200° C.,
H2) separating water and oil, optionally by applying an electrical field to polarize the water,
H3) extracting water, and
optionally H4) contacting the oil, or desalted oil from step H1-H3) with a fixed bed reactor at elevated temperatures of 250 to 450° C., at a pressure of 3 to 14 MPa, optionally in the presence of a catalyst.
